(19) United States
(12) Patent Application Publication
(10) Pub. No.: US 2025/0065890 A1
(43) Pub. Date: Feb. 27, 2025

(54) METHODS AND SYSTEMS FOR DRIVER MONITORING USING IN-CABIN CONTEXTUAL AWARENESS

(71) Applicant: Harman Becker Automotive Systems GmbH, Karlsbad-Ittersbach (DE)

(72) Inventors: Eric Theisinger, Otterbach (DE); Robert Franz Klaus Kempf, Eggolsheim (DE); Johannes Wolfgang Helmut Rabe, Unterschleißheim (DE); Volodymyr Ivanov, Odelzhausen (DE); Evgeniy Faerman, München (DE)

(21) Appl. No.: 18/725,627

(22) PCT Filed: Dec. 28, 2022
(86) PCT No.: PCT/IB2022/062848

§ 371 Date: Jun. 28, 2024

Related U.S. Application Data
(60) Provisional application No. 63/266,252, filed on Dec. 30, 2021.

(51) Int. Cl. B60W 50/00; B60Q 3/70; B60Q 3/80

(52) U.S. Cl. CPC B60W 50/0098; B60Q 3/70; B60Q 3/80; B60W 50/0097; B60W 2520/00; B60W 2540/10; B60W 2540/12; B60W 2540/20; B60W 2540/22; B60W 2540/225; B60W 2540/229

(57) ABSTRACT

Examples are disclosed for systems and methods for increasing a performance of a driver monitoring system (DMS) based on contextual information within a cabin of the vehicle. In one embodiment, a method comprises, during operation of a vehicle by a driver, collecting vehicle environment status information inside a cabin of the vehicle, the vehicle environment status information related to environmental factors that may impact a cognitive load of the driver and including at least one of information regarding one or more passengers of the vehicle; and information from one or more dashboard controls of the vehicle; and based on the vehicle environment status information and an estimated physiological state of the driver, adjusting one or more environmental controls of the vehicle.

### CROSS REFERENCE TO RELATED APPLICATIONS

The present application claims priority to U.S. Provisional Application No. 63/266,252, entitled “METHODS AND SYSTEMS FOR DRIVER MONITORING USING IN-CABIN CONTEXTUAL AWARENESS”, and filed on Dec. 30, 2021. The entire contents of the above-listed application are hereby incorporated by reference for all purposes.

### FIELD

The disclosure relates generally to increasing the performance of driver monitoring systems of vehicles.

### BACKGROUND

Current occupant monitoring systems (OMS) and/or driver monitoring system (DMS) may be used to estimate a physiological state (such as a drowsiness or a distraction), of an occupant of a vehicle, such as a driver of the vehicle. A DMS may be based on sensors including contactless sensors that analyze various aspects or parameters of driver behavior, such as, for example, head movement, eye gaze, and/or other similar aspects or parameters of driver behavior that may indicate or relate to the physiological state of the driver. For example, a first set of patterns in head movement and/or eye gaze data may indicate that the driver may be drowsy, a second set of patterns in the head movement and/or eye gaze data may indicate that the driver may be distracted, and so forth.

Next generation DMS systems extend the functionality in considering cognitive aspects or moods of the driver based on sensor data. If the physiological state of the driver can be accurately assessed or predicted, under certain circumstances, a controller of the vehicle may intervene to assist the driver in operating the vehicle, for example, via an advanced driver assistance system (ADAS). The ADAS intervention may increase a performance of the driver operating the vehicle, and/or improve a driving experience of the driver. For example, if the DMS detects that the driver is drowsy, the controller may alert the driver via an audio recording, adjust a responsiveness of an accelerator pedal or brake pedal of the vehicle, issue a visual or audio notification, adjust a lighting of the vehicle, adjust a heating, ventilation and air conditioning (HVAC) setting of the vehicle, and/or adjust a different control of the vehicle.

However, some drivers may be dissatisfied with interventions made by the controller, and may disable the DMS or ADAS of the vehicle. One reason for driver dissatisfaction may be that the interventions might not take into consideration a wide variety of driver behaviors, driving styles, temperaments, types of driving, and in-cabin and external scenarios presented when operating the vehicle. In particular, when estimating the physiological state of the driver, the DMS systems might not rely on other in-cabin sensor data, external sensor data, and/or vehicle-to-everything (V2X)/Telematics data, which may provide contextual information about the driver's physiological state. For example, the physiological state of the driver may be influenced by behavior of one or more passengers of the vehicle, audio content played in a cabin of the vehicle, a temperature or lighting of the cabin, a route the driver is following, a level of traffic, and/or other environmental factors that may affect a driver's physiological state.

### SUMMARY

In various embodiments, the issues described above may be addressed by a method, comprising collecting environmental status information inside a cabin of a vehicle during operation of the vehicle by a driver, the environmental status information related to environmental factors that may impact a physiological state (such as a drowsiness or a distraction) of the driver; collecting driver status information from a driver monitoring system (DMS) of the vehicle; predicting a physiological state of the driver based on the environmental status information and the driver status information; and adjusting one or more environmental controls of the vehicle based on the predicted physiological state of the driver. By including the environmental status information in a prediction of the physiological state of the driver, the physiological state of the driver may be more accurately predicted, and more precise and personalized interventions could be made, leading to increased adoption of DMS and ADAS systems and increased benefits offered by the DMS and ADAS systems.

Additionally, a personalized model of the driver may be created by collecting the driver status information and environmental status information, and analyzing the collected driver status information and environmental status information to detect patterns specific to the driver. The driver model may subsequently be used to adjust the one or more environmental controls of the vehicle based on the environmental status information and the driver status information. The driver model may be reinforced and updated over time with additional collected data, leading to increased performance. In this way, personalized intervention strategies may be created for assisting drivers and improving driving experiences of drivers.

Further, patterns in the driver status information and environmental status information across drivers may be discovered. Such patterns may be used to generate one or more generic driver models for general use, or one or more customized driver models for different types or categories of drivers.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a schematic block diagram of a vehicle control system, in accordance with one or more embodiments of the present disclosure;

FIG. 2 is a schematic block diagram that shows examples of data that may be received as input into a driver model of a vehicle control system, in accordance with one or more embodiments of the present disclosure;

FIG. 3A is a diagram showing a vehicle in communication with a cloud-based server that hosts a model of a driver of a vehicle, in accordance with one or more embodiments of the present disclosure;

FIG. 3B shows a data transmission timeline indicating a timing of a transmission of data from a vehicle to a cloud-based server, in accordance with one or more embodiments of the present disclosure;

FIG. 4 is a flowchart illustrating a method for collecting and transmitting data from a vehicle to a cloud-based server for development of a driver model, in accordance with one or more embodiments of the present disclosure;

FIG. 5 is a flowchart illustrating a method for adjusting one or more cabin controls of a vehicle based on a predicted physiological state of the driver, in accordance with one or more embodiments of the present disclosure;

FIG. 6 shows an exemplary dashboard of a vehicle including a plurality of controls, in accordance with one or more embodiments of the present disclosure; and

FIG. 7 is a schematic block diagram that shows an in-vehicle computing system and a control system of a vehicle, in accordance with one or more embodiments of the present disclosure.

### DETAILED DESCRIPTION

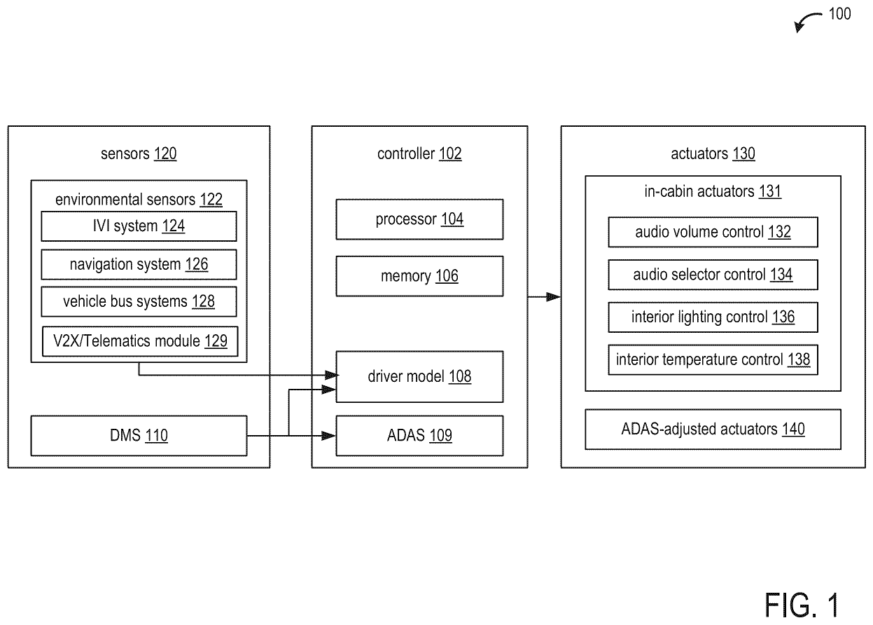

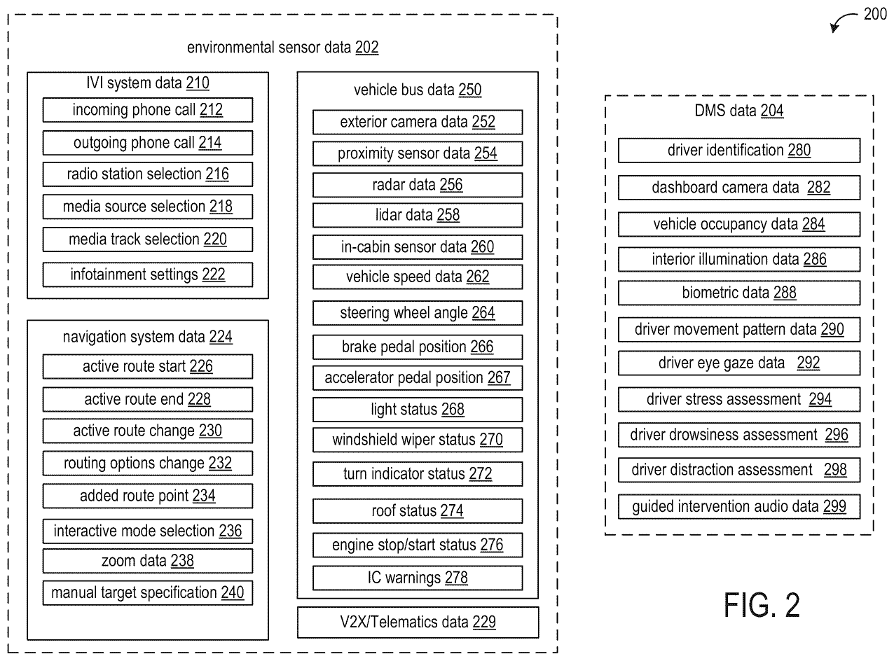

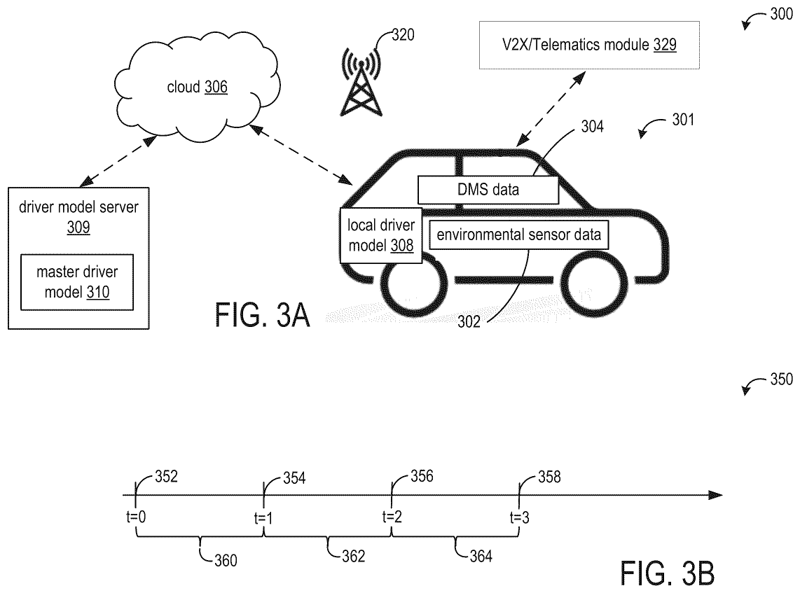

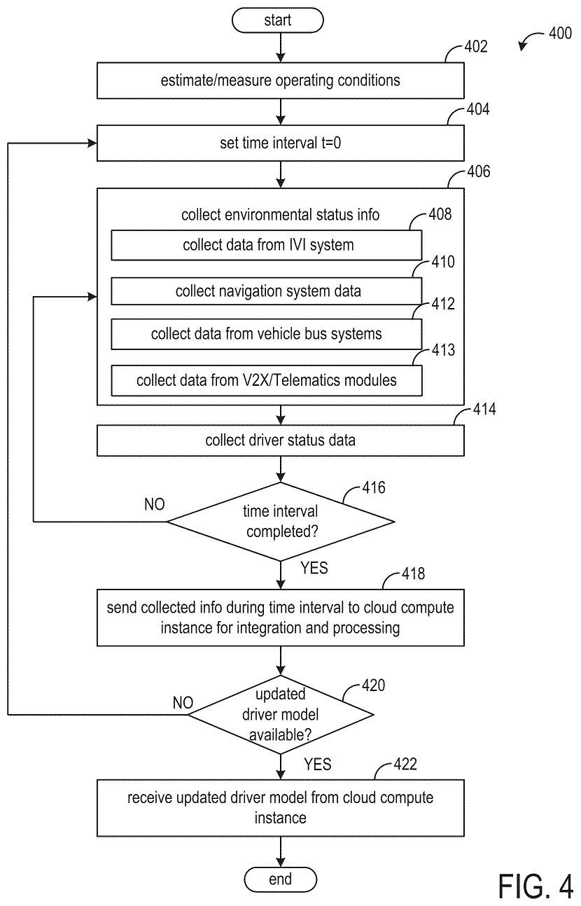

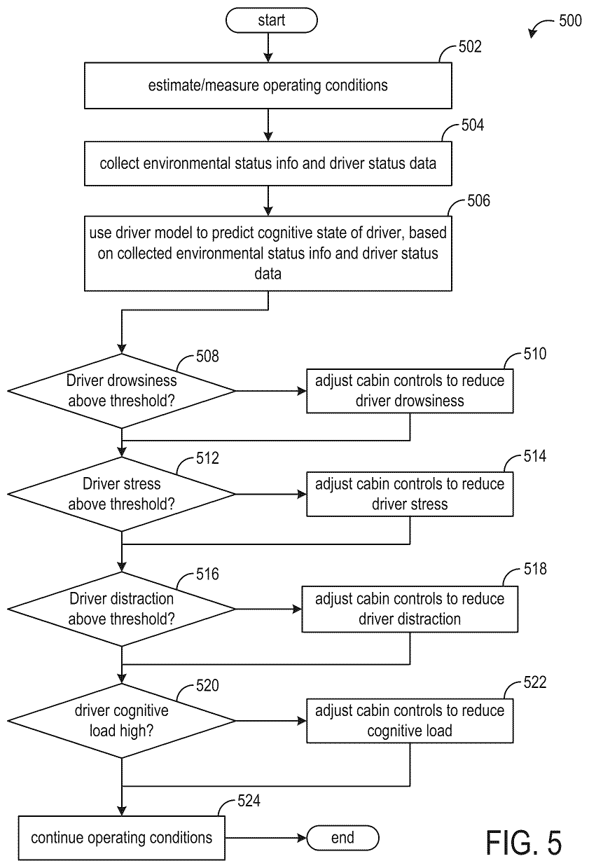

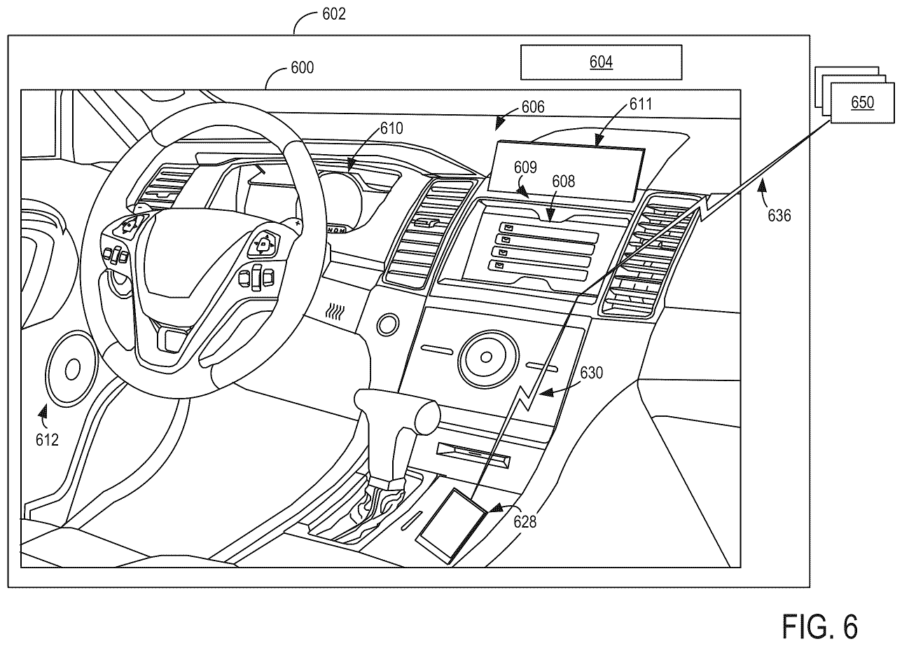

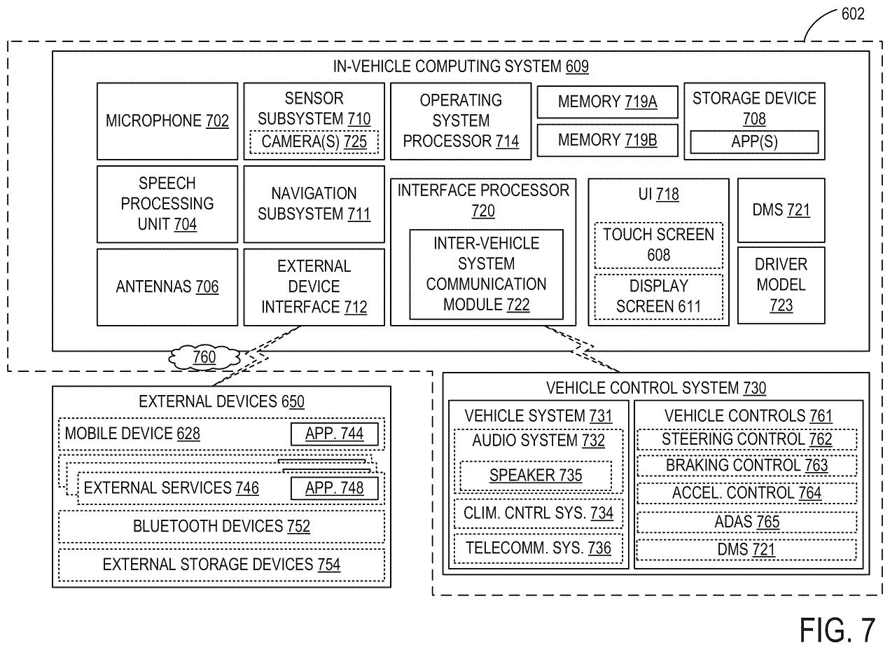

The following detailed description relates to increasing a performance of a driver monitoring system (DMS) of a vehicle by including environmental status information in addition to driver status data collected by the DMS. The DMS may be included in a vehicle control system, such as the vehicle control system shown in FIG. 1. The vehicle control system may be part of a larger in-vehicle computing system (such as the in-vehicle computing system of FIG. 7). A driver model stored in a memory of a controller of the vehicle control system may take as input the environmental sensor data and DMS data shown in FIG. 2. In various embodiments, the driver model may be created at a cloud based server as shown in FIG. 3A, and the driver model may be updated in accordance with a timeline shown in FIG. 3B. The driver model may be created and updated in accordance with a procedure such as the method shown in FIG. 4. One or more cabin controls of the vehicle may be adjusted based on an output of the driver model, in accordance with a procedure such as the method shown in FIG. 5. FIG. 6 shows an exemplary set of dashboard controls of a cabin of the vehicle, which may include the in-vehicle computing system of FIG. 7.

Referring now to FIG. 1, a simplified vehicle control system 100 of a vehicle is shown, including a controller 102, a plurality of sensors 120 of the vehicle, and a plurality of actuators 130 of the vehicle. Various outputs of sensors 120 may be used by controller 102 to adjust and/or control various actuators 130.

Sensors 120 may include a DMS 110, a V2X/Telematics module 129, and one or more environmental sensors 122, which may be used to collect environmental status information pertaining to a driver of the vehicle. DMS 110 may monitor the driver to detect or measure aspects of a physiological state of the driver (such as a drowsiness or a distraction), for example, via a dashboard camera of the vehicle, or via one or more sensors arranged in the cabin of the vehicle. Biometric data of the driver (e.g., vital signs, galvanic skin response, and so on) may be collected from a sensor of a driver's seat of the vehicle, or a sensor on a steering wheel of the vehicle, or a different sensor in the cabin. DMS 110 may analyze dashboard camera data, biometric data, and other data of the driver to generate an output.

Environmental sensors 122 may output environmental context information pertinent to the physiological state of the driver, such as a number of passengers in the vehicle, a noise level in the cabin of the vehicle, an amount of traffic surrounding the vehicle, and the like. Environmental sensors 122 may include, for example, sensors from an in-vehicle infotainment (IVI) system 124, a navigation system or navigational guidance system 126, one or more bus systems 128 of the vehicle, and/or a V2X/Telematics module 129. V2X/Telematics module 129 may include environmental sensors positioned outside the vehicle (e.g., at a Telematics box in an environment of the vehicle) via a wireless network (e.g., a cellular network). Controller 102 may include at least one processor 104, which may execute instructions stored on a memory 106 to control actuators 130 based at least partly on output of sensors 120. Controller 102 may also include a driver model 108 and an advanced driver assistance system (ADAS) 109. As described in greater detail herein, driver model 108 may predict a physiological state of a driver of the vehicle during operation of the vehicle. To predict the physiological state of the driver, in various embodiments, driver model 108 may receive various input from environmental sensors 122 and/or DMS 110, as described in greater detail in reference to FIG. 2.

Controller 102 may adjust or control one or more of actuators 130 of the vehicle based on ADAS 109 in order to assist the driver in operating the vehicle (such as by assisting the driver in braking, accelerating, and/or steering). In various embodiments, controller 102 may use data from both driver model 108 and ADAS 109 when adjusting or controlling actuators 130. In various embodiments, ADAS 109 may incorporate driver model 108.

Actuators 130 may include one or more ADAS-adjusted actuators 140 and/or one or more in-cabin actuators 131. ADAS-adjusted actuators 140 may include actuators pertaining to various driving-related operations of the vehicle, such as actuators related to braking, accelerating, and/or steering. In-cabin actuators 131 may include, for example, an audio volume control 132 of an audio system of the vehicle, an audio selector control 134 of the audio system, an interior lighting control 136 of the cabin, and/or an interior temperature control 138 of the cabin.

The output of DMS 110 may be used by controller 102 (and/or ADAS 109) to control one or more of actuators 130. For example, DMS 110 may detect a pattern in data of the driver received from the dashboard cam that may be associated with drowsiness, and as a result, may output a signal to ADAS 109 indicating that the driver may be drowsy. In response to the signal, ADAS 109 may adjust one or more of ADAS-adjusted actuators 140 (e.g., a brake of the vehicle) in accordance with an ADAS intervention strategy. In various embodiments, DMS 110 may similarly detect a pattern that may be associated with distraction.

Driver model 108 may receive input data from DMS 110 and environmental sensors 122. In some embodiments, raw data of DMS 110 (e.g., images from a dashboard camera, steering wheel and/or seat sensor data, and so on) may be an input into driver model 108. Additionally, or alternatively, one or more intermediate and/or final results of an analysis of the raw data by DMS 110 may be an input into driver model 108. For example, a pattern in driver behavior captured by DMS may be codified and provided as input into driver model 108 (e.g., the signal indicating that the driver may be drowsy). In various embodiments, driver model 108 may also receive input data from environmental sensors 122. Data supplied to driver model 108 by DMS 110 and environmental sensors 122 is described in greater detail below in reference to FIG. 2.

Based at least partially on inputs received from DMS 110 and environmental sensors 122, driver model 108 may output a predicted physiological state of the driver. In some embodiments, driver model 108 may be, or may include, a rules-based model, in which a plurality of rules may be applied to input data of driver model 108 to generate an output of driver model 108. For example, the rules may be established by experts based on an analysis of historical data of a plurality of drivers. Additionally, or alternatively, driver model 108 may be, or may include, a high-dimensional statistical model, in which one or more statistical methods may be used to recognize patterns in the input data. In some embodiments, a rules-based model may include a statistical model, and a rule of the rules-based model may be applied based on one or more patterns recognized by the statistical model. Additionally, or alternatively, driver model 108 may be, or may include, a machine (ML) model (e.g., a neural network model). In various embodiments, the ML model may output one or more indicators of a physiological state of the driver, based on some or all of the input data of driver model 108. One or more rules of the rules-based system may be applied to the output of the ML model to predict the physiological state of the driver, or the rules-based system might not be used, and ML model may predict the physiological state. In various embodiments, this may be considered a fusion of different input information.

Based on the predicted physiological state outputted by driver model 108, controller 102 may adjust one or more of actuators 130, such as one or more ADAS-adjusted actuators 140 and/or one or more in-cabin actuators 131. As an example, the driver may operate the vehicle when drowsy. As a result of being drowsy, the driver may exhibit a pattern of head movements (such as a periodic dipping of the driver's head). DMS 110 may detect the pattern of movements, and may codify the pattern of movements as potentially indicative of drowsiness. DMS 110 may output a signal to driver model 108 including the codified pattern of movements of the driver. In addition to receiving the codified pattern from DMS 110, driver model 108 may receive data from environmental sensors 122. For example, the environmental sensor data may include a temperature of the cabin, and/or one or more characterizations of an audio signal playing within the cabin. In the above example in which the driver may be operating the vehicle when drowsy, the temperature may correspond with a relatively warm temperature, a first characterization of the audio signal may be that the audio signal is relaxing music, and a second characterization of the audio signal may be that a volume of the audio signal is low.

Based on the codified pattern received from DMS 110, the warm temperature of the cabin, and the soft relaxing music playing in the cabin, driver model 108 may output a predicted physiological state of the driver, in which the predicted physiological state is drowsiness. Based on the predicted drowsy physiological state of the driver, controller 102 may actuate one or more of in-cabin actuators 131 to reduce the drowsiness of the driver. In some embodiments, controller 102 may adjust audio volume control 132 to increase an audio volume. For some embodiments, controller 102 may adjust audio selector control 134 to select a different audio file (e.g., music that is less relaxing and more energetic) to play in the cabin. In some embodiments, controller 102 may adjust interior lighting control 136 in order to move a frequency of interior lighting of the vehicle towards a blue spectrum, which may increase a focus of the driver. For some embodiments, controller 102 may adjust interior temperature control 138 to decrease a temperature of the cabin. As a result of the higher audio volume, the more energetic music, the bluer interior lighting, and/or the cooler cabin temperature, the drowsiness of the driver may be reduced.

As discussed herein, memory 106 may include any non-transitory computer readable medium in which instructions are stored. For the purposes of this disclosure, the term “non-transitory computer readable medium” is expressly defined to include any type of computer readable storage, which in various embodiments may include a non-transitory computer readable medium such as a flash memory, a read only memory (ROM), a random access memory (RAM), a cache, or any other storage media (e.g., a tangible medium) in which information is stored for any duration (e.g., for extended period time periods, permanently, brief instances, for temporarily buffering, and/or for caching of the information). Computer memory of computer readable storage mediums as referenced herein may include volatile and non-volatile or removable and non-removable media for a storage of electronic-formatted information such as computer readable program instructions or modules of computer readable program instructions, data, and the like that may be stand-alone or as part of a computing device. Examples of computer memory may include any other medium which can be used to store the desired electronic format of information and which can be accessed by the processor or processors or at least a portion of a computing device. Various methods and systems disclosed herein may be implemented using instructions (e.g., programming instructions, coded instructions, executable instructions, computer readable instructions, and the like) stored in a non-transitory computer readable medium.

Referring now to FIG. 2, a data schematic 200 shows examples of data that may be received as input into a driver model of a vehicle control system of a vehicle (e.g., driver model 108 of vehicle control system 100) by one or more environmental sensors of the vehicle control system and a by DMS of the vehicle control system (e.g., environmental sensors 122 and DMS 110 of FIG. 1). Data schematic 200 includes an exemplary set of environmental sensor data 202 and an exemplary set of DMS data 204.

Environmental sensor data 202 may include IVI system data 210, navigation system data 224, vehicle bus data 250, and V2X/Telematics data 229. In some embodiments, IVI system data 210 may include, for example, a detection of an incoming phone call 212, and/or a detection of an outgoing phone call 214. For some embodiments, IVI system data 210 may include detection of a radio station selection 216 (e.g., a detection of a user of the vehicle selecting a radio station), and/or a media source selection 218 (e.g., a detection of a user of the vehicle selecting a source of infotainment media, such as radio, phone, an online service like Spotify, a collection of stored content, and so on). In some embodiments, IVI system data 210 may include a media track selection 220 of the online service and/or collection of stored content, such as whether the driver or a user of the vehicle is searching for a specific track or browsing forward or backward through the online service and/or collection of stored content. For some embodiments, IVI system data 210 may include one or more infotainment settings 222 of the IVI system, such as for example, a language, font size, brightness, or a different setting.

In some embodiments, IVI system data 210 may include additional or alternative data not shown in FIG. 2. For example, IVI system data 210 may include data from one or more devices coupled to the vehicle either via a wired or wireless connection and/or paired with the vehicle, such as a tablet and/or smart phone of an occupant of the vehicle paired to the vehicle via a Bluetooth® connection. (Bluetooth® is a registered trademark of Bluetooth SIG, Inc., Kirkland, WA.)

Navigation system data 224 of environmental sensor data 202 may include information from a global positioning system (GPS)-based navigation system that may aid the driver in navigating the vehicle through a surrounding environment of the vehicle. Navigation system data 224 may include, for example, a global position of the vehicle, a relative position of the vehicle with respect to one or more traffic features and/or physical features of the surrounding environment, a type or characterization of a kind of driving undertaken by the driver (e.g., city driving, high-traffic scenario, and so on), route information (e.g., a destination of the driver), and/or other types of information produced by and/or made available by navigation systems.

In some embodiments, navigation system data 224 may include, for example, an active route start 226 (e.g., a detection that the driver has initiated a planned route), an active route end 228 (e.g., a detection that the driver has finished the planned route), an active route change 230 and/or a routing options change 232 (e.g., a detection that the driver has changed a routing option or selected an alternative route), and/or an added route point 234 (e.g., a detection that the driver has included an intermediate or additional destination on the planned route). For some embodiments, navigation system data 224 may include an interactive mode selection 236 of the navigation system, if the driver switches a map viewer of the navigation system to an interactive map mode, and/or zoom data 238, if the driver is zooming in or zooming out of a map displayed on the map viewer. In some embodiments, navigation system data 224 may also include a manual target specification 240 of the driver.

Vehicle bus data 250 of environmental sensor data 202 may be received from one or more bus systems of the vehicle, such as a controller area network (CAN) bus of the vehicle, a local interconnect network (LIN) bus of the vehicle, and/or an automotive Ethernet network of the vehicle. In some embodiments, vehicle bus data 250 may include exterior camera data 252 (e.g., images) outputted by one or more exterior cameras. For example, the vehicle may include one or more front-end exterior cameras arranged at a front end of the vehicle, one or more rear- and exterior camera arranged at a rear end of the vehicle, and/or one or more exterior cameras arranged at a side, undercarriage, or roof of the vehicle. The one or more exterior cameras outputting exterior camera data 252 may be used to aid the driver in backing up and/or adjusting a position of vehicle, for example, when parking the vehicle. The one or more exterior cameras outputting exterior camera data 252 may also be used to detect objects in a proximity to the vehicle. For example, the one or more exterior cameras outputting exterior camera data 252 may be used to detect one or more other vehicles operating next to or near the vehicle, a curb of a road the vehicle is operating on, one or more pedestrians positioned or moving near the vehicle, or other objects that may be encountered on or near the road.

For some embodiments, vehicle bus data 250 may also include proximity sensor data 254, radar data 256, and/or lidar data 258, which may also be used to detect objects in proximity to the vehicle. For example, radar data 256, lidar data 258, and proximity sensor data 254 for a front-end proximity sensor may be used to determine a distance between the vehicle and a leading vehicle, or the radar data 256, lidar data 258, and proximity sensor data 254 for a rear-end proximity sensor may be used to determine a distance between the vehicle and a following vehicle. Because a presence of one or more objects (e.g., vehicles) in proximity to the vehicle may increase a cognitive load of the driver and/or a level of stress of the driver, in various embodiments, proximity sensor data 254, radar data 256, and/or lidar data 258 may be used by the driver model to predict a physiological state of the driver.

In some embodiments, vehicle bus data 250 may include in-cabin sensor data 260. In-cabin sensor data 260 may include sensors arranged around an interior of a cabin of the vehicle, which may be used to detect contextual information of the cabin that could be pertinent to a physiological state of the driver. For example, in-cabin sensor data 260 may include one or more passenger seat sensors, which may indicate whether one or more respective passenger seats of the vehicle are occupied or unoccupied. In some embodiments, the one or more passenger seat sensors may output additional information of occupants of the one or more respective passenger seats, such as, for example, a weight of the occupants, temperatures of the occupants, or vital signs of the occupants, or a level of restlessness of the occupants, or a different characteristic of the occupants. In-cabin sensor data 260 may also include one or more in-cabin microphones, which may be arranged at any location within a cabin of the vehicle. For example, a microphone may be positioned on a ceiling of the cabin, or on a seat of the cabin, such as on the back of a front seat of the vehicle or on a headrest of one of the seats of the cabin, or in a console between two seats of the cabin, or in a door or side wall of the cabin, or at a different location of the cabin. The one or more in-cabin microphones may be used to determine a noise level in the cabin, or to differentiate between different types of noise present in the cabin. For example, the one or more in-cabin microphones may be used to detect the presence of a crying infant, or arguing children, cross conversation between occupants in different seats of the vehicle, and/or audio signals of devices of occupants or infotainment systems of the vehicle. In-cabin sensor data 260 may include cabin temperature data (e.g., an output of an in-cabin temperature sensor), or interior lighting data. The cabin temperature data may include one or more settings of an air conditioning (AC)/heating system of the vehicle, such as a target AC temperature status and/or any changes made by the driver, a strength status of an AC system and/or any changes made by the driver, and an AC mode (e.g., direct or diffuse).

For some embodiments, vehicle bus data 250 may include sensor data of one or more driving controls of the vehicle, such as vehicle speed data 262, a steering wheel angle 264, a brake pedal position 266, and/or an accelerator pedal position 267. For some embodiments, vehicle bus data 250 may include a light status 268, a windshield wiper status 270, and/or a roof status 274 (e.g., whether a roof of the vehicle is open or closed) which may be used to determine a level of visibility in an exterior environment and whether rain or snow may be falling. For some embodiments, vehicle bus data 250 may include a turn indicator status 272, which may indicate whether the drivers intending to turn the vehicle to the left or to the right, or to change lanes on a road. In some embodiments, vehicle bus data 250 may include an engine stop/start status 276 (e.g., a detection of whether an engine of the vehicle is on or off, for example, during a stop-start routine to save fuel). For some embodiments, vehicle bus data 250 may include one or more instrument cluster (IC) warnings 278 visible on a dashboard of the vehicle. For example, a check engine light may be detected, or a low fuel level indicator, a parking brake indicator, or a different IC warning.

For some embodiments, V2X/Telematics data 229 may include sensor data transmitted from a V2X/Telematics module (e.g., V2X/Telematics module 129) located outside the vehicle. For example, V2X/Telematics data 229 may include data collected in an environment of the vehicle, including weather or meteorological data, traffic data, road condition data, and the like.

Turning to DMS data 204, in some embodiments, DMS data 204 may include a driver identification 280. For example, the DMS may identify the driver based on a presence of a key fob of the driver at a driver's seat of the vehicle. In some embodiments, the identification of the driver may be used to retrieve a driving profile of the driver from a memory of the vehicle (e.g., memory 106 of controller 102 of FIG. 1) or on a cloud-based server (as disclosed further herein). For example, the driving profile of the driver may include driving style data of the driver (e.g., a braking style, an acceleration style, a steering style, and/or one or more preferential cruising speeds of the driver), and/or other data of the driver relevant to operation of the vehicle, such as a detection of one or more typical and/or historical behavioral patterns of the driver when operating the vehicle.

For some embodiments, DMS data 204 may include dashboard camera data 282 and/or vehicle occupancy data 284 of the vehicle. Dashboard camera data 282 may include images of a face and/or head of the driver. In some embodiments, dashboard camera data 282 may include data of one or more passengers of the vehicle. For example, dashboard camera data 282 may detect images of faces of occupants at one or more seats of the vehicle, which may be used to augment and/or generate vehicle occupancy data 284. Vehicle occupancy data 284 may also include data from one or more seat sensors, and/or seatbelt sensors.

For some embodiments, DMS data 204 may include interior illumination data 286 of the cabin of the vehicle and/or biometric data 288 of the driver. For example, one or more steering wheel sensors may output vital sign data of the driver, such as a heart rate of the driver. The one or more steering wheel sensors may include galvanic skin response data of the driver, or a different type of biometric sensor data.

Additionally, in some embodiments, DMS data 204 may include analysis and/or result data for a DMS. In other words, in addition to raw data collected by sensors of a DMS (e.g., dashboard cameras outputting dashboard camera data 282, biometric data 288), DMS data 204 may include intermediate and/or final determinations made by the DMS as a result of processing and analyzing the raw data. For example, the DMS may detect patterns in the raw data. The patterns of the raw data may include driver movement pattern data 290, which may be a pattern detected in how the driver moves his head and/or a different part of his body repeatedly or periodically in a specific manner. The patterns of the raw data may include driver eye gaze data 292, which may include what the driver is looking at and/or patterns where the driver shifts an eye gaze repeatedly or periodically at a specific manner.

As described above, the patterns of the raw data may be analyzed, codified and outputted by the DMS to a driver model, to aid in predicting a physiological state of the driver. For example, for some embodiments, the DMS may generate a driver stress assessment 294, which may be an estimated level of stress of the driver based on the patterns of the raw data. In some embodiments, the DMS may generate a driver drowsiness assessment 296, which may be an estimated level of drowsiness of the driver based on the patterns of the raw data. For some embodiments, DMS may generate a driver distraction assessment 298, which may be an estimated level of distraction of the driver based on the patterns of the raw data. Driver stress assessment 294, driver drowsiness assessment 296, and/or driver distraction assessment 298 may be used by the driver model, in addition to environmental sensor data 202, to predict the physiological state of the driver.

Additionally, in some embodiments, DMS data 204 may include guided intervention audio data 299. Guided intervention audio data 299 may include adjustments of settings of an audio system of the vehicle made as part of a guided intervention future of the vehicle. For example, guided intervention audio data 299 may include audio volume status data, audio volume level change data, a type of audio source (e.g., music, podcast, talk radio), and/or audio data of any guided audio interventions currently being played to the driver. For example, a guided audio intervention may include providing audio for breathing exercises, calming music, or other types of audio content used to alter a physiological state of the driver.

Referring now to FIG. 3A, a driver model updating diagram 300 is shown, including a vehicle 301 in communication with a driver model server 309 via a cloud 306. In various embodiments, vehicle 301 may access cloud 306 and driver model server 309 via a wireless network, such as a wireless cellular network 320, using a modem of the vehicle (not shown in FIG. 3A). The modem may wirelessly transmit and receive data in accordance with any of a variety of wireless communication protocols, such as various 3rd Generation Partnership Project (3GPP) specification releases.

Vehicle 301 may include a local driver model 308 (which may be the same as or substantially similar to driver model 108 of FIG. 1). As described above in reference to FIGS. 1 and 2, local driver model 308 may receive, as inputs, environmental sensor data 302 and DMS data 304 of vehicle 301 (which may be substantially similar to environmental sensor data 202 and/or DMS data 204, respectively, of FIG. 2).

In various embodiments, local driver model 308 may be based on one or more master driver models 310 on driver model server 309. Specifically, a master driver model 310 may be initially created based on DMS data 304 and environmental sensor data 302, which may be received by driver model server 309 from vehicle 301 over wireless cellular network 320. Software running on driver model server 309 may integrate and process DMS data 304 and environmental sensor data 302 to generate master driver model 310. After master driver model 310 has been created, a copy of master driver model 310 may be transmitted to vehicle 301 via wireless cellular network 320 become local driver model 308. In this way, a greater processing power and greater number of computing resources of driver model server 309 with respect to vehicle 301 may be taken advantage of to analyze patterns in DMS data 304 and environmental sensor data 302, and local driver model 308 may be used locally to adjust one or more actuators of the vehicle based on driver behavior and in-cabin environmental context. By including local driver model 308 in vehicle 301, the adjusting of the one or more actuators may be performed more rapidly, without a latency of transmitting data over wireless cellular network 320.

Vehicle 301 may also me in wireless communication with a V2X/Telematics module 329, which may be substantially similar to V2X/Telematics module 129 of FIG. 1 and/or a V2X/Telematics module for transmitting V2X/Telematics data such as V2X/Telematics data 229 of FIG. 2. V2X/Telematics module 329 may transmit sensor data to vehicle 301 relating to environmental conditions (e.g., weather, traffic, road conditions, and the like) via wireless cellular network 320.

FIG. 3B shows a data transmission timeline 350, which may indicate a timing of a transmission of DMS data 304 and/or environmental sensor data 302. Data transmission timeline 350 includes a first point 352 at time t=0, which may represent an initial time at which DMS data 304 and/or environmental sensor data 302 begin to be collected by vehicle 301. A first set of DMS data 304 and/or environmental sensor data 302 may be collected over a first time interval 360. At time t=1, indicated by a second point 354, first time interval 360 may end. At the end of first time interval 360, sufficient DMS data 304 and/or environmental sensor data 302 may have been collected at vehicle 301 to create and/or contribute to (e.g., via a training process) a first master driver model (e.g., a master driver model 310) at driver model server 309.

At time t=1, the first set of DMS data 304 and/or environmental sensor data 302 collected at vehicle 301 during first time interval 360 may be transmitted to driver model server 309. During a second time interval 362, extending from time t=1 to time t=2, the first set of DMS data 304 and environmental sensor data 302 collected during first time interval 360 may be integrated and analyzed by software running at driver model server 309 to generate the first master driver model. Concurrently, a second set of DMS data 304 and environmental sensor data 302 may be collected at vehicle 301.

At time t=2, indicated by a point 356 of timeline 350, second time interval 362 may end. When second time interval 362 ends, a copy of the first master driver model may be transmitted to vehicle 301 to become a first local driver model (e.g., local driver model 308). Concurrently, the second set of DMS data 304 and environmental sensor data 302 collected during second time interval 362 may be transmitted to driver model server 309 for processing and integration.

In some embodiments, the sending of the second set of DMS data 304 and environmental sensor data 302 to driver model server 309 and the receiving of the first local driver model at vehicle 301 may both occur at time t=2. In other embodiments, the sending of the second set of DMS data 304 and environmental sensor data 302 to driver model server 309 and the receiving of the first local driver model at vehicle 301 may occur at different times. For example, either of the sending of the second set of DMS data 304 and environmental sensor data 302 to driver model server 309 and the receiving of the first local driver model at vehicle 301 may occur prior to time t=2, or after time t=2. In some embodiments, a first set of time intervals may be used for collecting the environmental sensor data 302 and the DMS data 304, and a second, different set of time intervals may be used for transmitting copies of master driver model 310 to vehicle 301. Additionally, the environmental sensor data 302 and the DMS data 304 may be collected over various time intervals before sufficient data is amassed to generate the first master driver model.

During a third time interval 364 extending from time t=2 to time t=3, the second set of DMS data 304 and the environmental sensor data 302 collected during second time interval 362 may be integrated and analyzed by the software running at driver model server 309 to generate a second master driver model (e.g., a master driver model 310). Concurrently, a third set of DMS data 304 and environmental sensor data 302 may be collected at vehicle 301.

At time t=3, indicated by a point 358 of timeline 350, third time interval 364 may end. When third time interval 364 ends, a copy of the second master driver model may be transmitted to vehicle 301 to replace the first local driver model, where the copy is an updated version of the first master driver model that accommodates new or different patterns of behavior detected and analyzed during second time interval 362. In this way, environmental sensor data 302 and DMS data 304 may be regularly transmitted from vehicle 301 to driver model server 309 to update master driver model 310, and at various time intervals, a new copy of master driver model 310 may be transmitted to vehicle 301 to replace local driver model 308.

In various examples, the integration and processing of the DMS data 304 and the environmental sensor data 302 at driver model server 309 may be carried out based on rules-based and/or machine learning technologies, as described in greater detail below in reference to FIGS. 4, 5, and 6. During the integration and processing over subsequent time intervals, the rules-based and/or machine learning technologies may be used to adjust parameters of master driver model 310. Over time, a driver of vehicle 301 may develop one or more new or different patterns of behavior as result of more, less, or different stressors in the driver's life. For example, during third time interval 364, the driver might not be getting sufficient sleep, whereby the driver may operate vehicle 301 in a drowsier physiological state than is typical for the driver. Additionally, or alternatively, the driver may operate vehicle 301 with additional and/or different passengers during third time interval 364 than during second time interval 362. Thus, driver model server 309 may adjust master driver model 310 to accommodate the new or different patterns of behavior.

In some embodiments, first time interval 360, second time interval 362, and third time interval 364 may be the same. In other words, local driver model 308 may be updated after regular time intervals based on master driver model 310. In other embodiments, first time interval 360, second time interval 362, and third time interval 364 might not be the same, where local driver model 308 might not be updated after regular time intervals, and may rather be updated after irregular time intervals. Alternatively, the environmental sensor data 302 and the DMS data 304 may be transmitted continuously to driver model server 309. In some embodiments, the environmental sensor data 302 and the DMS data 304 may be transmitted to driver model server 309 based on a DMS status result. In some embodiments, a transmission of the environmental sensor data 302 and the DMS data 304 may be triggered if an observed state (e.g., by the DMS) of the driver deviates from current profile parameters of the driver above a defined threshold. For example, the transmission may be triggered if an observed distraction pattern of the driver (e.g., a frequency, intensity and/or type of distraction) deviates from a historical or typical distraction pattern, such as, for example, if the driver is observed to have a first level of distraction interacting with a system of the vehicle, when the driver was observed to have a second level of distraction in the past.

Referring now to FIG. 4, an example method 400 is shown for collecting and transmitting environmental status information and DMS data from a vehicle to a cloud-based server for development of a driver model, and receiving a copy of the driver model transmitted from the cloud-based server. The environmental status information, DMS data, cloud-based server, and driver model may be substantially similar to environmental sensor data 202 and/or DMS data 204 of FIG. 2, and driver model server 309 and/or local driver model 308 of FIG. 3A, respectively. Instructions for carrying out method 400 may be executed by a controller of the vehicle, such as controller 102 of vehicle control system 100 of FIG. 1.

At a part 402, method 400 includes estimating and/or measuring vehicle operating conditions. For example, the vehicle operating conditions may include, but are not limited to, a status of an engine of the vehicle (e.g., whether the engine is switched on), and an engagement of one or more gears of a transmission of the vehicle (e.g., whether the vehicle is moving). Vehicle operating conditions may include engine speed and load, vehicle speed, transmission oil temperature, exhaust gas flow rate, mass air flow rate, coolant temperature, coolant flow rate, engine oil pressures (e.g., oil gallery pressures), operating modes of one or more intake valves and/or exhaust valves, electric motor speed, battery charge, engine torque output, vehicle wheel torque, and so on. In one example, the vehicle is a hybrid electric vehicle, and estimating and/or measuring vehicle operating conditions includes determining whether the vehicle is being powered by an engine or an electric motor. Estimating and/or measuring vehicle operating conditions may further include identifying a driver of the vehicle. For example, the driver may be identified by a proximity of a key fob of the driver.

At a part 404, method 400 includes setting a timer of a time interval to zero. In various embodiments, the time interval may be a duration of time during which environmental status information and DMS data of the vehicle is collected and stored in a memory of the vehicle.

At a part 406, method 400 includes collecting the environmental status information. At a part 408, collecting the environmental status information includes collecting data from an IVI system of the vehicle. The IVI system may be substantially similar to IVI system 124 of FIG. 1, and the data from the IVI system may include a portion or all of the IVI system data 210 of FIG. 2. For example, the data from the IVI system may include a detection of whether the driver has received an incoming phone call or is making an outgoing phone call; selection data of audio content of an audio system of the vehicle, such as a radio station selection or selection of a different media source, and/or a selection of an individual track of the different media source (e.g., a song from a collection of songs, or podcast); and/or one or more settings of the IVI system, such as a language, or a personalization of the IVI system. It should be appreciated that the above list is provided for illustrative purposes, and more, less, or different data may be included in the IVI system data without departing from the scope of this disclosure.

At a part 410, collecting the environmental status information includes collecting data from a navigational system of the vehicle. The navigational system may be substantially similar to navigational guidance system 126 of FIG. 1, and the data from the navigation system may include a portion or all of the navigation system data 224 of FIG. 2. For example, the data from the navigation system may include a detection that a route to a destination manually selected by the driver has been initiated, completed, or is currently underway. The data from the navigation system may also include a detection of any changes made to the route by the driver, such as switching from a first route proposed by the navigation system to a second route proposed by the navigation system, and/or any manual changes made to the route by the driver, such as any additional destinations added. The data from the navigation system may include data regarding an interaction between the driver and the navigation system, such as whether the driver is currently changing settings of the navigation system via a voice interface or a touchscreen interface. For example, the driver may be manually specifying a destination, visually examining a portion of the route, zooming in or zooming out of a display of the route, or using an interactive mode selection of the navigation software. It should be appreciated that the above list is provided for illustrative purposes, and more, less, or different data may be included in the navigation system data without departing from the scope of this disclosure.

At a part 412, collecting the environmental status information includes collecting data from one or more bus systems of the vehicle. The one or more bus systems of the vehicle may include, for example, a CAN bus, a LIN, bus and/or an automotive Ethernet network of the vehicle. The one or more bus systems may be substantially similar to vehicle bus systems 128 of FIG. 1, and the data from the one or more bus systems may include a portion or all of the vehicle bus data 250 of FIG. 2. For example, the data from the bus systems may include object proximity and/or detection data received from one or more exterior cameras, proximity sensors, radar and/or lidar systems of the vehicle. The data from the bus systems may include data from one or more in-cabin sensors of the vehicle, such as a temperature of the cabin, a level of lighting of the cabin, or level of noise in the cabin. The data from the bus systems may include vehicle control data during operation of the vehicle, such as a speed of the vehicle (e.g., from a wheel speed sensor), a position of a brake pedal of the vehicle, a position of an accelerator of the vehicle, and a position of a steering wheel the vehicle (e.g., an angle of the steering wheel from a default angle of zero when the vehicle is operating in a straight line and not turning). The data from the bus systems may also include status data of one or more windshield wipers of the vehicle, one or more turn signals of the vehicle, and/or a position of a movable roof (e.g., open or closed, open to a certain degree) of the vehicle. The data from the bus systems may also include, for example, an engine status of the vehicle, one or more system warnings indicated to a user via a dashboard of the vehicle, engine temperature data, fuel level data, or additional and/or alternative data from other systems of the vehicle. It should be appreciated that the above list is provided for illustrative purposes, and more, less, or different data may be included in the bus system data without departing from the scope of this disclosure.

At a part 413, collecting the environmental status information includes collecting data from one or more V2X/Telematics modules in an environment of the vehicle. As described above in reference to FIGS. 1-3, the one or more V2X/Telematics modules may transmit sensor data including meteorological/weather data, road condition data, traffic data, and/or other types of data.

At a part 414, method 400 includes collecting driver status data of the driver. In various embodiments, the driver status data may include data from a DMS system of the vehicle. The DMS system may be substantially similar to DMS 110 of FIG. 1, and the data from the DMS system may include a portion or all of the DMS data 204 of FIG. 2. The driver status data and/or the data from the DMS system may include data from one or more interior (e.g., dashboard) cameras of the vehicle; biometric data received from one or more sensors arranged at the steering wheel, seat, or at another location in the vehicle; a level of interior illumination inside the vehicle, and whether the interior illumination is automatic, manually selected, and/or a result of the driver opening a door of the vehicle; and/or seat occupancy data received from seat sensors of the vehicle and/or in-cabin cameras of the vehicle.

The data of the DMS system may further include one or more results of processing and/or analysis performed by the DMS system of raw data received by the DMS system. For example, the dashboard camera data and biometric data may track head movements and/or an eye gaze of the driver, and the DMS system may detect patterns in the head movements and/or eye gaze, and may further codify the detected patterns. The codifications of the detected patterns may be used as input into various processes of the DMS system. The various processes of the DMS system may analyze the codifications of detected patterns along with other data of the DMS system to generate an assessment of a physiological state of the user. For example, the DMS system data may include an assessment of a stress level of the driver, a level of drowsiness of the driver, a level of distraction of the driver, and/or a cognitive load of the driver. In some embodiments, the DMS system data may also include guided intervention data of the DMS system. For example, if the DMS system determines that the driver may be experiencing a high level of stress, the DMS system may intervene with audio data (e.g., calming music, breathing exercises, and the like) to attempt to calm the driver down.

At a part 416, method 400 includes determining whether the time interval started at part 404 has been completed. If at part 416 it is determined that the time interval has not been completed, method 400 proceeds back to part 406, and method 400 continues to collect the environmental status information. Alternatively, if at part 416 it is determined that the time interval has been completed, method 400 proceeds to a part 418.

At part 418, method 400 includes sending the environmental status information and driver status data collected over the time interval to a cloud-based compute instance for integration and processing to generate or regenerate the driver model. In other words, if no driver model has been generated, a first set of environmental status information and/or the driver status data (collectively also referred to herein as physiological state data) may be processed to create an initial driver model. If an initial driver model has already been generated, a subsequent set of environmental status information and/or physiological state data may be integrated into the first set of environmental status information and/or physiological state data to create a combined set of environmental status information and/or physiological state data. The combined set of environmental status information and/or physiological state data may then be processed to generate a subsequent driver model.

As described above in reference to FIG. 1, the driver model may be or include a rules-based model that outputs a predicted physiological state of the driver based on applying one or more rules of the rules-based model to the collected environmental status information and driver status data. In various embodiments, the rules may be generated based on an analysis of historical data of a plurality of drivers. Some of the rules of the rules-based model may be generated manually by examining the collected environmental status information and/or physiological state data. For example, one or more experts may identify broad patterns or groupings of data from which one or more general rules may be created.

In some embodiments, the rules may be generated by applying one or more statistical methods for detecting patterns in high dimensional data to the physiological state data. In various embodiments, the patterns may include patterns in a variance, frequency, and/or intensity of physiological state changes, applying one or more thresholds and/or time averaging methods. The statistical methods may include a deviation from a median or a mean, a cluster analysis, a correlation, a regression, or a different statistical method. In some embodiments, a statistical evaluation of percentages may be applied in combination with set theory. As an example, 82% of the drivers may show an increased distraction for 5 seconds, when a driver is in a conversation with a passenger while listening to music and the radio switches to news while conversation is ongoing. As another example, 95% of the drivers may show an increased level of drowsiness when listening to relaxing music while driving at a constant speed on an empty highway and not making periodic changes to an IVI setting or lane changes, and not having a conversation with passengers.

In some embodiments, the rules may be generated by training a ML model to detect patterns in the physiological state data. If a first physiological state is detected, the ML model may output a first indicator of the first physiological state of the driver; if a second physiological state is detected, the ML model may output a second indicator of the second physiological state of the driver; if a third physiological state is detected the ML model may output a third indicator of the third physiological state of the driver; and so on. In some embodiments, training of the ML model may be accomplished via supervised learning, where ground truth data may be generated from dependency graphs (e.g., by determining a physiological state of the driver prior to the driver executing a braking event, an acceleration event, and/or a steering event). In other embodiments, training of the ML model may be accomplished via unsupervised learning, where the ML model is trained without ground truth data.

At a part 420, method 400 includes determining whether an updated driver model is available to be downloaded at the vehicle. If at part 420 it is determined that an updated driver model is not available for downloading at the vehicle, method 400 proceeds back to part 404, and the time interval timer is reset to zero. Alternatively, if at part 420 it is determined that an updated driver model is available for downloading at the vehicle, method 400 proceeds to a part 422.

At part 422, method 400 includes receiving the updated driver model from the cloud-based compute instance, and method 400 ends.

Referring now to FIG. 5, an example method 500 is shown for adjusting one or more cabin controls of a vehicle based on a physiological state of the driver, where the physiological state is predicted by a driver model (e.g., local driver model 308 of FIG. 3A). Instructions for carrying out method 500 may be executed by a controller of the vehicle, such as controller 102 of vehicle control system 100 of FIG. 1.

At a part 502, method 500 includes estimating and/or measuring vehicle operating conditions, as described above in reference to method 400 of FIG. 4. In various embodiments, estimating and/or measuring vehicle operating conditions may include determining whether a driver model has been installed in a memory (e.g., memory 106) of the vehicle.

At a part 504, method 500 includes collecting environmental status information of the vehicle and driver status data of the vehicle, also as described above in reference to method 400. The environmental status information and driver status data may be substantially similar to environmental sensor data 202 and DMS data 204 of FIG. 2.

At a part 506, method 500 includes using the driver model to predict one or more physiological states of the driver, based on the collected environmental status information and the driver status data. As described above in reference to method 400, the driver model may include or be a combination of a rules-based model, a statistical model, a ML model, or a different type of model that outputs the predicted physiological state of the driver based on the collected environmental status information and driver status data. In various embodiments, the one or more predicted physiological states of the driver may include a predicted level of drowsiness of the driver; a predicted level of stress of the driver; a predicted level of distraction of the driver; and/or a predicted physiological state of the driver. In other embodiments, the one or more predicted physiological states of the driver may correspond to a predicted physiological state (e.g., drowsiness, stress, distraction, and/or cognitive load) of a type of driver that the driver model associates with the driver.

In some embodiments, using the driver model to predict one or more physiological states of the driver based on the collected environmental status information and the driver status data may include predicting the one or more physiological states of the driver based on a driver classification of the driver. For example, in some situations and/or for some drivers, there might not be sufficient environmental status information and driver status data to develop a driver model accurate enough to predict the driver's physiological state. However, the collected environmental status information and driver status data may be sufficient to assign the driver to a driver classification based on one or more physiological states. For example, the driver may be assigned a first driver classification indicative of a first physiological state (e.g., drowsy); the driver may be assigned a second driver classification indicative of a second physiological state (e.g., distracted); the driver may be assigned a third driver classification indicative of a third physiological state (e.g., focused); and so on.

At a part 508, method 500 includes determining whether the predicted level of drowsiness of the driver is above a threshold level of drowsiness. In various embodiments, the threshold level of drowsiness may be determined by one or more rules of the driver model. For example, a rule of the driver model may specify that if a pattern of movements of the driver captured by a dashboard camera of the vehicle matches a pattern of movements associated with drowsiness, then the threshold level of drowsiness is achieved. Alternatively, a rule may specify that if the pattern of movements is detected above a threshold number of times, and/or for a threshold duration, that a threshold level of drowsiness is achieved. If at part 508 it is determined that the predicted level of drowsiness of the driver is above the threshold level of drowsiness, method 500 proceeds to a part 510. Alternatively, if at part 508 it is determined that the predicted level of drowsiness of the driver is not above the threshold level of drowsiness, method 500 proceeds to a part 512.

At part 510, method 500 includes adjusting cabin controls to reduce the predicted drowsiness of the driver. In some embodiments, adjusting the cabin controls to reduce the drowsiness of the driver may include adjusting an interior lighting of the cabin. For example, light with a frequency closer to a blue spectrum may induce focus and concentration in the driver to a higher degree than light with a frequency further from the blue spectrum. Therefore, the interior lighting of the cabin may be adjusted to increase the focus and concentration of the driver. Similarly, adjusting the cabin controls to reduce the drowsiness of the driver may also include lowering a temperature of the cabin. In various embodiments, an adjustment to an interior lighting of the cabin may pertain to an intensity of the lighting, a frequency of the lighting, a pattern of the lighting, and/or a color of the lighting. For various embodiments, instead of or in addition to an adjustment to a temperature of the cabin, an adjustment may be made to an HVAC setting, an air flow, an audio signal, an audio alert, and/or visual notifications (e.g., using a DC/IVI system).

In some embodiments, adjusting the cabin controls to reduce the predicted drowsiness of the driver may include altering one or more settings of an audio system of the vehicle, or prompting the driver to alter the one or more settings of the audio system. Certain types of audio content may be more conducive to drowsiness than other types of audio content. For example, a potential contributor to the drowsiness of the driver may be a soft, quiet music playing over the audio system, whereby the controller may adjust the cabin controls to increase a volume of the music, and/or prompt the driver to change the music to a different type of music.

For example, the controller may issue an audio notification alerting the driver to a possible physiological state of drowsiness of the driver. The controller may further provide to the driver one or more suggested adjustments to the cabin controls for selection by the driver. In some embodiments, the controller may suggest a different type of audio content that the driver model associates with a more energetic mood of the driver, or a different type of audio content that is generally associated with a more energetic mood of the driver type of the driver, or of people in general. In other embodiments, the controller may suggest or initiate a guided audio intervention, where a specific type of audio content is played to reduce the drowsiness of the driver. An associated may accordingly be made between a detected mood and music or audio that may influence the detected mood in a certain direction. For example, if a detected mood includes a state of anger, music perceived as relaxing may help to influence the state of anger toward a state of calmness.

At part 512, method 500 includes determining whether the predicted level of stress of the driver is above a threshold level of stress. In various embodiments, the threshold level of stress may be determined by one or more rules of the driver model. For example, a rule of the driver model may specify that if a pattern of movements of the driver captured by a dashboard camera of the vehicle matches a pattern of movements associated with stress, then the threshold level of drowsiness is achieved. Alternatively, a rule may specify that if the pattern of movements for stress is detected a threshold number of times, and/or for a threshold duration, that a threshold level of stress is achieved. The threshold level of stress may also be determined by biometric data of the driver (e.g., the biometric data 288 of FIG. 2) such as a pulse rate, where if the pulse rate of the driver exceeds a typical driving pulse rate of the driver by a percent (e.g., 30%), then the threshold level of stress is achieved. For example, the pulse rate of the driver may be detected by a sensor of a steering wheel of the vehicle. If at part 512 it is determined that the predicted level of stress of the driver is above the threshold level of stress, method 500 proceeds to a part 514. Alternatively, if at part 512 it is determined that the predicted level of stress of the driver is not above the threshold level of stress, method 500 proceeds to a part 516.

At part 514, method 500 includes adjusting cabin controls to reduce the predicted level of stress of the driver. For some embodiments, an adjustment may include navigation information or advice (such as information regarding a different route with less traffic and/or wider roads). In some embodiments, adjusting the cabin controls to reduce the predicted level of stress of the driver may include altering one or more settings of the audio system of the vehicle, or prompting the driver to alter the one or more settings of the audio system. Certain types of audio content may be more conducive to stress than other types of audio content.

For example, the controller may issue an audio notification alerting the driver to a possible physiological state of stress of the driver. The controller may further provide to the driver one or more suggested adjustments to the cabin controls for selection by the driver. In some embodiments, the controller may suggest a different type of audio content that the driver model associates with a less stressful state of the driver, or a different type of audio content that is generally associated with a less stressful state of the driver type of the driver, or of people in general. In other embodiments, the controller may suggest or initiate a guided audio intervention, where a specific type of audio content is played to reduce the stress of the driver. For example, the guided audio intervention may include calming words, breathing exercises, or similar audio content.

At part 516, method 500 includes determining whether the predicted level of distraction of the driver is above a threshold level of distraction. In various embodiments, the threshold level of distraction may be determined by one or more rules of the driver model. If a rule of the driver model specifies that if a pattern of movements of the driver captured by a dashboard camera of the vehicle matches a pattern of movements associated with a distracted driver (e.g., if the driver is not frequently looking at a road the vehicle is on), then the threshold level of distraction may be achieved. Alternatively, a rule may specify that if the pattern of movements associated with the distracted driver is detected a threshold number of times, and/or for a threshold duration, that a threshold level of distraction is achieved. The threshold level of distraction may also be determined by a tone or quality of a voice of the driver when the driver is on a phone call, or by a combination of different detected patterns. If at part 516 it is determined that the predicted level of distraction of the driver is above the threshold level of distraction, method 500 proceeds to a part 518. Alternatively, if at part 516 it is determined that the predicted level of distraction of the driver is not above the threshold level of distraction, method 500 proceeds to a part 520.

At part 518, method 500 includes adjusting cabin controls to reduce the distraction of the driver. For example, a fan speed of an HVAC system of the vehicle may be increased, an interior lighting of the cabin may be increased, a volume of audio content in the cabin may be increased, and/or IVI content may be minimized.

At part 520, method 500 includes determining whether the predicted physiological state of the driver is above a threshold value. For example, the predicted physiological state could be a cognitive load of the driver, and the predicted cognitive load may be a value between 0 and 1, where the threshold cognitive load is 1. If at part 520 it is determined that the predicted cognitive load of the driver is above the threshold cognitive load, method 500 proceeds to a part 522. Alternatively, if at part 520 it is determined that the predicted cognitive load of the driver is not above the threshold cognitive load, method 500 proceeds to a part 524.

At part 522, method 500 includes adjusting cabin controls to impact the physiological state of the driver. For example, when the physiological state of the driver is a cognitive load of the driver, part 522 may include adjusting cabin controls to reduce the cognitive load of the driver. For example, interior lighting of the cabin may be adjusted, one or more HVAC settings may be adjusted, an audio notification of a high predicted cognitive load may be issued (e.g., a verbal notification, either recorded or synthesized), and so on.

At part 524, method 500 includes continuing operating conditions of the vehicle, and method 500 ends.

FIG. 6 shows an interior of a cabin 600 of a vehicle 602, in which a driver and/or one or more passengers may be seated. Vehicle 602 of FIG. 6 may be a motor vehicle including drive wheels (not shown) and an internal combustion engine 604. Internal combustion engine 604 may include one or more combustion chambers which may receive intake air via an intake passage and exhaust combustion gases via an exhaust passage. Vehicle 602 may be a road automobile, among other types of vehicles. In some examples, vehicle 602 may include a hybrid propulsion system including an energy conversion device operable to absorb energy from vehicle motion and/or the engine and convert the absorbed energy to an energy form suitable for storage by an energy storage device. Vehicle 602 may include a fully electric vehicle, incorporating fuel cells, solar energy capturing elements, and/or other energy storage systems for powering the vehicle.

Further, in some examples, vehicle 602 may be an autonomous vehicle. In some examples, vehicle 602 is a fully autonomous vehicle (e.g., fully self-driving vehicle) configured to drive without a user input. For example, vehicle 602 may independently control vehicle systems in order to direct the vehicle to a desired location, and may sense environmental features in order to direct the vehicle (e.g., such as via object detection). In some examples, vehicle 602 is a partially autonomous vehicle. In some examples, vehicle 602 may have an autonomous mode, in which the vehicle operates without user input, and a non-autonomous mode, in which the user directs the vehicle. Further, in some examples, while an autonomous vehicle control system may primarily control the vehicle in an autonomous mode, a user may input commands to adjust vehicle operation, such as a command to change a vehicle speed, a command to brake, a command to turn, and the like. In still other examples, the vehicle may include at least one ADAS for partially controlling the vehicle, such as a cruise control system, a collision avoidance system, a lane change system, and the like.

Vehicle 602 may include a plurality of vehicle systems, including a braking system for providing braking, an engine system for providing motive power to wheels of the vehicle, a steering system for adjusting a direction of the vehicle, a transmission system for controlling a gear selection for the engine, an exhaust system for processing exhaust gases, and the like. Further, the vehicle 602 includes an in-vehicle computing system 609. The in-vehicle computing system 609 may include an autonomous vehicle control system for at least partially controlling vehicle systems during autonomous driving. As an example, while operating in an autonomous mode, the autonomous vehicle control system may monitor vehicle surroundings via a plurality of sensors (e.g., such as cameras, radars, ultrasonic sensors, a GPS signal, and the like). The in-vehicle computing system 609 is described in greater detail below in reference to FIG. 7.

As shown, an instrument panel 606 may include various displays and controls accessible to a human user (e.g., a driver or a passenger) of vehicle 602. For example, instrument panel 606 may include a touch screen 608 of an in-vehicle computing system or infotainment system 609 (e.g., an infotainment system), an audio system control panel, and an instrument cluster 610. Touch screen 608 may receive user input to the in-vehicle computing system or infotainment system 609 for controlling audio output, visual display output, user preferences, control parameter selection, and so on. In some examples, instrument panel 606 may include an input device for a user to transition the vehicle between an autonomous mode and a non-autonomous mode. For example, the vehicle includes an autonomous mode in which the autonomous vehicle control system operates the vehicle at least partially independently, and a non-autonomous mode, in which a vehicle user operates the vehicle. The vehicle user may transition between the two modes via the user input of instrument panel 606. Further, in some examples, instrument panel 606 may include one or more controls for the autonomous vehicle control system, such as for selecting a destination, setting desired vehicle speeds, setting navigation preferences (e.g., a preference for highway roads over city streets), and the like. Further still, in some examples, instrument panel 606 may include one or more controls for driver assistance programs, such as a cruise control system, a collision avoidance system, and the like. Further, additional user interfaces, not shown, may be present in other portions of the vehicle, such as proximate to at least one passenger seat. For example, the vehicle may include a row of back seats with at least one touch screen controlling the in-vehicle computing system 609.

While the example system shown in FIG. 6 includes audio system controls that may be performed via a user interface of in-vehicle computing system or infotainment system 609, such as touch screen 608 without a separate audio system control panel, in other embodiments, the vehicle may include an audio system control panel, which may include controls for a conventional vehicle audio system such as a radio, compact disc player, MP3 player, and so on. The audio system controls may include features for controlling one or more aspects of audio output via one or more speakers 612 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system or infotainment system 609 may adjust a radio station selection, a playlist selection, a source of audio input (e.g., from radio or CD or MP3), and so on, based on user input received directly via touch screen 608, or based on data regarding the user (such as a physical state and/or environment of the user) received via one or more external devices 650 and/or a mobile device 628. The audio system of the vehicle may include an amplifier (not shown) coupled to plurality of loudspeakers (not shown). In some embodiments, one or more hardware elements of in-vehicle computing system or infotainment system 609, such as touch screen 608, a display screen 611, various control dials, knobs and buttons, memory, processor(s), and any interface elements (e.g., connectors or ports) may form an integrated head unit that is installed in instrument panel 606 of the vehicle. The head unit may be fixedly or removably attached in instrument panel 606. In additional or alternative embodiments, one or more hardware elements of the in-vehicle computing system or infotainment system 609 may be modular and may be installed in multiple locations of the vehicle.

The cabin 600 may include one or more sensors for monitoring the vehicle, the user, and/or the environment. For example, the cabin 600 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 600, and so on. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, and so on. Information regarding ambient conditions of the vehicle, vehicle status, or vehicle driver may also be received from sensors external to/separate from the vehicle (that is, not part of the vehicle system), such as sensors coupled to external devices 650 and/or mobile device 628. Sensor data of various sensors of the vehicle may be transmitted to and/or accessed by the in-vehicle computing system 609 via a bus of the vehicle, such as a CAN bus.

Cabin 600 may also include one or more user objects, such as mobile device 628, that are stored in the vehicle before, during, and/or after travelling. The mobile device 628 may include a smart phone, a tablet, a laptop computer, a portable media player, and/or any suitable mobile computing device. The mobile device 628 may be connected to the in-vehicle computing system via a communication link 630. The communication link 630 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Wi-Fi® and Wi-Fi Direct® are registered trademarks of Wi-Fi Alliance, Austin, Texas.) The mobile device 628 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 630 may provide sensor and/or control signals from various vehicle systems (such as vehicle audio system, climate control system, and so on) and the touch screen 608 to the mobile device 628 and may provide control and/or display signals from the mobile device 628 to the in-vehicle systems and the touch screen 608. The communication link 630 may also provide power to the mobile device 628 from an in-vehicle power source in order to charge an internal battery of the mobile device.

In-vehicle computing system or infotainment system 609 may also be communicatively coupled to additional devices operated and/or accessed by the user but located external to vehicle 602, such as one or more external devices 650. In the depicted embodiment, external devices are located outside of vehicle 602 though it will be appreciated that in alternate embodiments, external devices may be located inside cabin 600. The external devices may include a server computing system, personal computing system, portable electronic device, electronic wrist band, electronic head band, portable music player, electronic activity tracking device, pedometer, smart-watch, GPS system, and so on. External devices 650 may be connected to the in-vehicle computing system via a communication link 636 which may be wired or wireless, as discussed with reference to communication link 630, and configured to provide two-way communication between the external devices and the in-vehicle computing system. For example, external devices 650 may include one or more sensors and communication link 636 may transmit sensor output from external devices 650 to in-vehicle computing system or infotainment system 609 and touch screen 608. External devices 650 may also store and/or receive information regarding contextual data, user behavior/preferences, operating rules, and so on and may transmit such information from the external devices 650 to in-vehicle computing system or infotainment system 609 and touch screen 608.

In-vehicle computing system or infotainment system 609 may analyze the input received from external devices 650, mobile device 628, and/or other input sources and select settings for various in-vehicle systems (such as climate control system or audio system), provide output via touch screen 608 and/or speakers 612, communicate with mobile device 628 and/or external devices 650, and/or perform other actions based on the assessment. In some embodiments, all or a portion of the assessment may be performed by the mobile device 628 and/or the external devices 650.

In some embodiments, one or more of the external devices 650 may be communicatively coupled to in-vehicle computing system or infotainment system 609 indirectly, via mobile device 628 and/or another of the external devices 650. For example, communication link 636 may communicatively couple external devices 650 to mobile device 628 such that output from external devices 650 is relayed to mobile device 628. Data received from external devices 650 may then be aggregated at mobile device 628 with data collected by mobile device 628, the aggregated data then transmitted to in-vehicle computing system or infotainment system 609 and touch screen 608 via communication link 630. Similar data aggregation may occur at a server system and then transmitted to in-vehicle computing system or infotainment system 609 and touch screen 608 via communication link 636 and/or communication link 630.

FIG. 7 shows a block diagram of an in-vehicle computing system or infotainment system 609 configured and/or integrated inside vehicle 602. In-vehicle computing system or infotainment system 609 may perform one or more of the methods described herein in some embodiments. In some examples, the in-vehicle computing system or infotainment system 609 may be a vehicle infotainment system configured to provide information-based media content (audio and/or visual media content, including entertainment content, navigational services, and so on) to a vehicle user to enhance the operator's in-vehicle experience. The in-vehicle computing system or infotainment system 609 may include, or be coupled to, various vehicle systems, sub-systems, hardware components, as well as software applications and systems that are integrated in, or integratable into, vehicle 602 in order to enhance an in-vehicle experience for a driver and/or a passenger. Further, the in-vehicle computing system may be coupled to systems for providing autonomous vehicle control.

In-vehicle computing system or infotainment system 609 may include one or more processors including an operating system processor 714 and an interface processor 720. Operating system processor 714 may execute an operating system on the in-vehicle computing system, and control input/output, display, playback, and other operations of the in-vehicle computing system. Interface processor 720 may interface with a vehicle control system 730 via an inter-vehicle system communication module 722.

Inter-vehicle system communication module 722 may output data to one or more other vehicle systems 731 and/or one or more other vehicle control elements 761, while also receiving data input from other vehicle systems 731 and other vehicle control elements 761, e.g., by way of vehicle control system 730. When outputting data, inter-vehicle system communication module 722 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as GPS sensors, and so on), digital signals propagated through vehicle data networks (such as an engine CAN bus through which engine related information may be communicated, a climate control CAN bus through which climate control related information may be communicated, and a multimedia data network through which multimedia data is communicated between multimedia components in the vehicle). For example, vehicle data outputs may be output to vehicle control system 730, and vehicle control system 730 may adjust vehicle controls 761 based on the vehicle data outputs. As another example, the in-vehicle computing system or infotainment system 609 may retrieve from the engine CAN bus the current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

A storage device 708 may be included in in-vehicle computing system or infotainment system 609 to store data such as instructions executable by operating system processor 714 and/or interface processor 720 in non-volatile form. The storage device 708 may store application data, including prerecorded sounds, to enable the in-vehicle computing system or infotainment system 609 to run an application for connecting to a cloud-based server and/or collecting information for transmission to the cloud-based server. The application may retrieve information gathered by vehicle systems/sensors, input devices (e.g., a user interface 718), data stored in one or more storage devices, such as a volatile memory 719A or a non-volatile memory 719B, devices in communication with the in-vehicle computing system (e.g., a mobile device connected via a Bluetooth® link), and so on. In-vehicle computing system or infotainment system 609 may further include a volatile memory 719A. Volatile memory 719A may be RAM. Non-transitory storage devices, such as non-volatile storage device 708 and/or non-volatile memory 719B, may store instructions and/or code that, when executed by a processor (e.g., operating system processor 714 and/or interface processor 720), controls the in-vehicle computing system or infotainment system 609 to perform one or more of the actions described in the disclosure.

A microphone 702 may be included in the in-vehicle computing system or infotainment system 609 to receive voice commands from a user, to measure ambient noise in the vehicle, to determine whether audio from speakers of the vehicle is tuned in accordance with an acoustic environment of the vehicle, and so on. A speech processing unit 704 may process voice commands, such as the voice commands received from the microphone 702. In some embodiments, in-vehicle computing system or infotainment system 609 may also be able to receive voice commands and sample ambient vehicle noise using a microphone included in an audio system 732 of the vehicle.

One or more additional sensors may be included in a sensor subsystem 710 of the in-vehicle computing system or infotainment system 609. For example, the sensor subsystem 710 may include a plurality of cameras 725, such as a rear view camera for assisting a user in parking the vehicle and/or other external cameras, radars, lidars, ultrasonic sensors, and the like. The sensor subsystem 710 may include an in-cabin camera (e.g., a dashboard cam) for identifying a user (e.g., using facial recognition and/or user gestures). For example, an in-cabin camera may be used to identify one or more users of the vehicle via facial recognition software, and/or to detect a status or state of the one or more users (e.g., drowsy, distracted, stressed, high cognitive load, and so on). Sensor subsystem 710 of in-vehicle computing system or infotainment system 609 may communicate with and receive inputs from various vehicle sensors and may further receive user inputs. For example, the inputs received by sensor subsystem 710 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a fob sensor receiving commands from and optionally tracking the geographic location/proximity of a fob of the vehicle, and so on.

One or more additional sensors may be included in and/or communicatively coupled to a sensor subsystem 710 of the in-vehicle computing system 700. For example, the sensor subsystem 710 may include and/or be communicatively coupled to a camera, such as a rear view camera for assisting a user in parking the vehicle, a cabin camera for identifying a user, and/or a front view camera to assess quality of the route segment ahead. The above-described cameras may also be used to provide images to a computer vision-based facial recognition and/or facial analysis module. For example, the facial analysis module may be used to determine an emotional or psychological state of users of the vehicle. Sensor subsystem 710 of in-vehicle computing system 609 may communicate with and receive inputs from various vehicle sensors and may further receive user inputs.

While certain vehicle system sensors may communicate with sensor subsystem 710 alone, other sensors may communicate with both sensor subsystem 710 and vehicle control system 730, or may communicate with sensor subsystem 710 indirectly via vehicle control system 730. Sensor subsystem 710 may serve as an interface (e.g., a hardware interface) and/or processing unit for receiving and/or processing received signals from one or more of the sensors described in the disclosure.

A navigation subsystem 711 of in-vehicle computing system or infotainment system 609 may generate and/or receive navigation information such as location information (e.g., via a GPS sensor and/or other sensors from sensor subsystem 710), route guidance, traffic information, point-of-interest (POI) identification, and/or provide other navigational services for the user. Navigation sub-system 711 may include inputs/outputs including analog to digital converters, digital inputs, digital outputs, network outputs, radio frequency transmitting devices, and so on. In some examples, navigation sub-system 711 may interface with vehicle control system 730.

An external device interface 712 of in-vehicle computing system or infotainment system 609 may be coupleable to and/or communicate with one or more external devices 650 located external to vehicle 602. While the external devices are illustrated as being located external to vehicle 602, it is to be understood that they may be temporarily housed in vehicle 602, such as when the user is operating the external devices while operating vehicle 602. In other words, the external devices 650 are not integral to vehicle 602. The external devices 650 may include a mobile device 628 (e.g., connected via a Bluetooth®, NFC, Wi-Fi Direct®, or other wireless connection) or an alternate Bluetooth®-enabled device 752.

Mobile device 628 may be a mobile phone, smart phone, wearable devices/sensors that may communicate with the in-vehicle computing system via wired and/or wireless communication, or other portable electronic device(s). Other external devices include one or more external services 746. For example, the external devices may include extra-vehicular devices that are separate from and located externally to the vehicle. Still other external devices include one or more external storage devices 754, such as solid-state drives, pen drives, USB drives, and so on. External devices 650 may communicate with in-vehicle computing system or infotainment system 609 either wirelessly or via connectors without departing from the scope of this disclosure. For example, external devices 650 may communicate with in-vehicle computing system or infotainment system 609 through the external device interface 712 over a network 760, a USB connection, a direct wired connection, a direct wireless connection, and/or other communication link.

The external device interface 712 may provide a communication interface to enable the in-vehicle computing system to communicate with mobile devices associated with contacts of the driver. For example, the external device interface 712 may enable phone calls to be established and/or text messages (e.g., Short Message Service (SMS), Multimedia Message Service (MMS), and so on) to be sent (e.g., via a cellular communication network) to a mobile device associated with a contact of the driver. The external device interface 712 may additionally or alternatively provide a wireless communication interface to enable the in-vehicle computing system to synchronize data with one or more devices in the vehicle (e.g., the driver's mobile device) via Wi-Fi Direct®.

One or more applications 744 may be operable on mobile device 628. As an example, a mobile device application 744 may be operated to aggregate user data regarding interactions of the user with the mobile device. For example, mobile device application 744 may aggregate data regarding music playlists listened to by the user on the mobile device, telephone call logs (including a frequency and duration of telephone calls accepted by the user), positional information including locations frequented by the user and an amount of time spent at each location, and so on. The collected data may be transferred by application 744 to external device interface 712 over network 760. In addition, specific user data requests may be received at mobile device 628 from in-vehicle computing system or infotainment system 609 via the external device interface 712. The specific data requests may include requests for determining where the user is geographically located, an ambient noise level and/or music genre at the user's location, an ambient weather condition (temperature, humidity, and so on) at the user's location, and so on. Mobile device application 744 may send control instructions to components (e.g., microphone, amplifier and so on) or other applications (e.g., navigational applications) of mobile device 628 to enable the requested data to be collected on the mobile device or requested adjustment made to the components. Mobile device application 744 may then relay the collected information back to in-vehicle computing system or infotainment system 609.

Likewise, one or more applications 748 may be operable on external services 746. As an example, external services applications 748 may be operated to aggregate and/or analyze data from multiple data sources. For example, external services applications 748 may aggregate data from one or more social media accounts of the user, data from the in-vehicle computing system (e.g., sensor data, log files, user input, and so on), data from an internet query (e.g., weather data, POI data), and so on. The collected data may be transmitted to another device and/or analyzed by the application to determine a context of the driver, vehicle, and environment and perform an action based on the context (e.g., requesting/sending data to other devices).

The one or more applications 748 operable on external services 746 may include a cloud-based driver model generation service, which may receive data of a driver of the vehicle from the vehicle 602. The data of the driver may include, for example, driving data (e.g., acceleration style, braking style, steering style, and so on). The data of the driver may also include in-cabin environmental data, such as preferred settings for lighting, temperature, preferred audio content, typical cabin context data (e.g., how often the driver drives with passengers, whether the passengers are children, head movement and/or eye gaze patterns detected via a dashboard cam, and the like. The data of the driver may be used to generate a model or profile of the driver, which may be used, for example, to personalize an intervention by an ADAS system of the vehicle 602, or to personalize an adjustment to in-cabin environmental controls based on driver behavior.

Vehicle control system 730 may include controls for controlling aspects of various vehicle systems 731 involved in different in-vehicle functions. These may include, for example, controlling aspects of vehicle audio system 732 for providing audio entertainment to the vehicle occupants, aspects of a climate control system 734 for meeting the cabin cooling or heating needs of the vehicle occupants, as well as aspects of a telecommunication system 736 for enabling vehicle occupants to establish telecommunication linkage with others.

Audio system 732 may include one or more acoustic reproduction devices including electromagnetic transducers such as one or more speakers 735. Vehicle audio system 732 may be passive or active such as by including a power amplifier. In some examples, in-vehicle computing system or infotainment system 609 may be a sole audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 734 may be configured to provide a comfortable environment within the cabin or passenger compartment of vehicle 602. Climate control system 734 includes components enabling controlled ventilation such as air vents, a heater, an air conditioner, an integrated heater and air-conditioner system, and so on. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 730 may also include controls for adjusting the settings of various vehicle control elements 761 (or vehicle controls, or vehicle system control elements) related to the engine and/or auxiliary elements within a cabin of the vehicle, such as one or more steering wheel controls 762 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 761 may also include internal engine and vehicle operation controls (e.g., engine controller module, actuators, valves, and so on) that are configured to receive instructions via the CAN bus of the vehicle to change operation of one or more of the engine, exhaust system, transmission, and/or other vehicle system. The control signals may also control audio output at one or more speakers 735 of the vehicle's audio system 732. For example, the control signals may adjust audio output characteristics such as volume, equalization, audio image (e.g., the configuration of the audio signals to produce audio output that appears to a user to originate from one or more defined locations), audio distribution among a plurality of speakers, and so on. Likewise, the control signals may control vents, air conditioner, and/or heater of climate control system 734. For example, the control signals may increase delivery of cooled air to a specific section of the cabin. For example, the control signals may increase delivery of cooled air to a specific section of the cabin. Additionally, while operating in an autonomous mode, the autonomous vehicle control system may control some or all of the above vehicle controls.

Vehicle controls 761 may include a steering control system 762, a braking control system 763, and an acceleration control system 764. Vehicle controls 761 may include additional control systems. In some example, vehicle controls 761 may be operated autonomously, such as during autonomous vehicle operation. In other examples, vehicle controls 761 may be controlled by a user. Further, in some examples, a user may primarily control vehicle controls 761, while one or more ADAS 765 may intermittently adjust vehicle controls 761 in order to increase vehicle performance. For example, the one or more ADAS 765 may include a cruise control system, a lane departure warning system, a collision avoidance system, an adaptive braking system, and the like.

Steering control system 762 may be configured to control a direction of the vehicle. For example, during a non-autonomous mode of operation, steering control system 762 may be controlled by a steering wheel. For example, the user may turn the steering wheel in order to adjust a vehicle direction. During an autonomous mode of operation, steering control system 762 may be controlled by vehicle control system 730. In some examples, one or more ADAS 765 may adjust steering control system 762. For example, the vehicle control system 730 may determine that a change in vehicle direction is requested, and may change the vehicle direction via controlling the steering control system 762. For example, vehicle control system 730 may adjust axles of the vehicle in order to change the vehicle direction.

Braking control system 763 may be configured to control an amount of braking force applied to the vehicle. For example, during a non-autonomous mode of operation, braking control system 763 may be controlled by a brake pedal. For example, the user may depress the brake pedal in order to increase an amount of braking applied to the vehicle. During an autonomous mode of operation, braking system 763 may be controlled autonomously. For example, the vehicle control system 730 may determine that additional braking is requested, and may apply additional braking. In some examples, the autonomous vehicle control system may depress the brake pedal in order to apply braking (e.g., to decrease vehicle speed and/or bring the vehicle to a stop). In some examples, the one or more ADAS 765 may adjust braking control system 763.

Acceleration control system 764 may be configured to control an amount of acceleration applied to the vehicle. For example, during a non-autonomous mode of operation, acceleration control system 764 may be controlled by an acceleration pedal. For example, the user may depress the acceleration pedal in order to increase an amount of torque applied to wheels of the vehicle, causing the vehicle to accelerate in speed. During an autonomous mode of operation, acceleration control system 764 may be controlled by vehicle control system 730. In some examples, the one or more ADAS 765 may adjust acceleration control system 764. For example, vehicle control system 730 may determine that additional vehicle speed is requested, and may increase vehicle speed via acceleration. In some examples, vehicle control system 730 may depress the acceleration pedal in order to accelerate the vehicle. As an example of an ADAS 765 adjusting acceleration control system 764, the ADAS 765 may be a cruise control system, and may include adjusting vehicle acceleration in order to maintain a desired speed during vehicle operation.

Control elements positioned on an outside of a vehicle (e.g., controls for a security system) may also be connected to in-vehicle computing system or infotainment system 609, such as via inter-vehicle system communication module 722. The control elements of the vehicle control system may be physically and permanently positioned on and/or in the vehicle for receiving user input. In addition to receiving control instructions from in-vehicle computing system or infotainment system 609, vehicle control system 730 may also receive input from one or more external devices 650 operated by the user, such as from mobile device 628. This allows aspects of vehicle systems 731 and vehicle control elements 761 to be controlled based on user input received from the external devices 650.

In-vehicle computing system or infotainment system 609 may further include one or more antennas 706. The in-vehicle computing system may obtain broadband wireless internet access via antennas 706, and may further receive broadcast signals such as radio, television, weather, traffic, and the like. The in-vehicle computing system or infotainment system 609 may receive positioning signals such as GPS signals via antennas 706. The in-vehicle computing system may also receive wireless commands via radio frequency (RF) such as via antennas 706 or via infrared or other means through appropriate receiving devices. In some embodiments, antenna 706 may be included as part of audio system 732 or telecommunication system 736. Additionally, antenna 706 may provide AM/FM radio signals to external devices 650 (such as to mobile device 628) via external device interface 712.

One or more elements of the in-vehicle computing system or infotainment system 609 may be controlled by a user via user interface 718. User interface 718 may include a graphical user interface presented on a touch screen, such as touch screen 608 and/or display screen 611 of FIG. 6, and/or user-actuated buttons, switches, knobs, dials, sliders, and so on. For example, user-actuated elements may include steering wheel controls, door and/or window controls, instrument panel controls, audio system settings, climate control system settings, and the like. A user may also interact with one or more applications of the in-vehicle computing system or infotainment system 609 and mobile device 628 via user interface 718. In addition to receiving a user's vehicle setting preferences on user interface 718, vehicle settings selected by in-vehicle control system may be displayed to a user on user interface 718. Notifications and other messages (e.g., received messages), as well as navigational assistance, may be displayed to the user on a display of the user interface. User preferences/information and/or responses to presented messages may be performed via user input to the user interface.

The in-vehicle computing system or infotainment system 609 may include a DMS 721. The DMS 721 may receive data from various sensors and/or systems of the vehicle (e.g., sensor subsystem 710, cameras 725, microphone 702) and may monitor aspects of driver behavior to improve a performance of the vehicle and/or a driving experience of the driver. For example, an output of the DMS 721 may be used to adjust a cabin lighting of the vehicle, or a temperature of the vehicle, if the DMS 721 detects driver behavior indicative of drowsiness. In some examples, one or more outputs of the DMS 721 may be inputs into a driver model 723. In various embodiments, the driver model 723 may be used to predict a physiological state of the driver, and adjust one or more controls of the vehicle control system 730 based on the predicted physiological state of the driver.

Thus, methods and systems are disclosed for increasing a performance of a DMS system by including environmental status information along with DMS data when assessing or predicting a physiological state of the driver. The environmental status information and the DMS data may be collected and analyzed for individual drivers at a cloud-based compute instance, allowing for the creation of personalized models that can be installed in vehicles. The personalized models may lead to more accurate predictions of the physiological state of a driver. The personalized driver models may be used to adjust one or more environmental controls of the vehicle based on new environmental status information and new DMS data collected in real time, and the driver model may be updated over time as the new environmental status information and new DMS data is collected, leading to driver models that are increasingly accurate. In this way, personalized intervention strategies may be created for assisting drivers and improving driving experiences of drivers.

The technical effect of including environmental status information along with DMS data when assessing or predicting the physiological state of the driver is that an intervention strategy based on DMS output may be more personalized for the driver, leading to increased adoption of DMS and driver assistance systems.

The disclosure provides support for a method, comprising: collecting environmental status information inside a cabin of a vehicle during operation of the vehicle by a driver, the environmental status information related to environmental factors that may impact a cognitive load of the driver, collecting driver status information from a DMS of the vehicle, predicting a physiological state of the driver based on the environmental status information and the driver status information, and adjusting one or more environmental controls of the vehicle based on the predicted physiological state of the driver. In a first example of the method, the driver status information includes at least one of: identification information of the driver, output of a dashboard camera of the vehicle, seat occupancy data of the vehicle, interior illumination data of the vehicle, biometric data of the driver, a drowsiness assessment of the driver, a stress assessment of the driver, a distraction assessment of the driver, eye gaze data of the driver, head movement data of the driver, and data of a guided audio intervention system of the vehicle. In a second example of the method, optionally including the first example, the environmental status information includes at least one of: information from a navigational system of the vehicle, information from an IVI system of the vehicle, and information from one or more bus systems of the vehicle. In a third example of the method, optionally including one or both of the first and second examples, the information from the navigational system includes at least one of: a start of an active route of the vehicle, an end of the active route of the vehicle, a change of the active route of the vehicle, an added destination of the active route of the vehicle, an interactive mode selection of the navigational system, and a command by the driver to zoom in or zoom out of a map of the navigational system. In a fourth example of the method, optionally including one or more or each of the first through third examples, the information from the IVI system includes at least one of: a detection of an incoming phone call, a detection of an outgoing phone call, a radio station selection, a media source selection, a media track selection, and one or more settings of the IVI system. In a fifth example of the method, optionally including one or more or each of the first through fourth examples, the information from the one or more bus systems of the vehicle includes sensor data of the vehicle, the sensor data including at least one of: exterior camera data of the vehicle, proximity sensor data of the vehicle, radar data of the vehicle, lidar data of the vehicle, in-cabin sensor data, vehicle speed data, steering wheel angle data, brake pedal position data, accelerator pedal position data, a status of one or more lights of the vehicle, a status of a windshield wiper of the vehicle, a status of a turn indicator of the vehicle, a status of a sun roof of the vehicle, a status of an engine of the vehicle, and one or more instrument cluster warnings of the vehicle. In a sixth example of the method, optionally including one or more or each of the first through fifth examples, adjusting the one or more environmental controls of the vehicle based on the predicted physiological state of the driver includes at least one of: adjusting a lighting of the cabin, adjusting a temperature of the cabin, and adjusting an audio signal generated by an audio system of the vehicle. In a seventh example of the method, optionally including one or more or each of the first through sixth examples, adjusting the audio signal further includes at least one of: adjusting a volume of the audio signal, and terminating the audio signal and initiating a different audio signal. In an eighth example of the method, optionally including one or more or each of the first through seventh examples, adjusting the one or more environmental controls of the vehicle based on the predicted physiological state of the driver includes adjusting the one or more environmental controls based upon at an output of least one of: an ML model, and a statistical model, and wherein the environmental status information and the driver status information are inputs into the at least one of the ML model and the statistical model. In a ninth example of the method, optionally including one or more or each of the first through eighth examples, adjusting the one or more environmental controls of the vehicle based on the predicted physiological state of the driver further includes adjusting the one or more environmental controls based on a classification of the driver.

The disclosure also provides support for a method, comprising: using a trained ML model to predict a physiological state of a driver of a vehicle based on: a detected physiological state of the driver, the detected physiological state being detected from a DMS of the vehicle, and one or more pieces of environmental status information, the environmental status information including data relevant to the physiological state of the driver, and based on the predicted physiological state, adjusting one or more environmental controls of a cabin of the vehicle. In a first example of the method, the environmental status information further includes one or more of: data of an IVI system of the vehicle, data of a navigation system of the vehicle, and data from one or more bus systems of the vehicle. In a second example of the method, optionally including the first example, the data of the IVI system includes at least one of: a detection of an incoming phone call, a detection of an outgoing phone call, a radio station selection, a media source selection, a media track selection, and one or more settings of the IVI system, wherein the data of the navigation system includes at least one of: a start of an active route of the vehicle, an end of the active route of the vehicle, a change of the active route of the vehicle, an added destination of the active route of the vehicle, an interactive mode selection of the navigation system, and a command by the driver to zoom in or zoom out of a map of the navigation system, and wherein the data from one or more bus systems of the vehicle includes at least one of: exterior camera data of the vehicle, proximity sensor data of the vehicle, radar data of the vehicle, lidar data of the vehicle, in-cabin sensor data, vehicle speed data, steering wheel angle data, brake pedal position data, accelerator pedal position data, a status of one or more lights of the vehicle, a status of a windshield wiper of the vehicle, a status of a turn indicator of the vehicle, a status of a sun roof of the vehicle, a status of an engine of the vehicle, and one or more instrument cluster warnings of the vehicle. In a third example of the method, optionally including one or both of the first and second examples, adjusting the one or more environmental controls of the vehicle based on the predicted physiological state of the driver includes at least one of: adjusting a lighting of the cabin, adjusting a temperature of the cabin, and adjusting a volume of an audio signal generated by an audio system of the vehicle, and terminating the audio signal and initiating a different audio signal. In a fourth example of the method, optionally including one or more or each of the first through third examples, adjusting the one or more environmental controls of the cabin of the vehicle further includes: in a first condition, where the predicted physiological state exceeds a threshold physiological state, adjusting the one or more environmental controls, and in a second condition, where the predicted physiological state does not exceed the threshold physiological state, not adjusting the one or more environmental controls. In a fifth example of the method, optionally including one or more or each of the first through fourth examples, the threshold physiological state is a threshold physiological state specific to the driver.

The disclosure also provides support for a system of a vehicle, comprising: one or more processors having executable instructions stored in a non-transitory memory that, when executed, cause the one or more processors to: predict a level of stress of a driver of the vehicle based on data including environmental sensor data of a cabin of the vehicle and a detected physiological state of the driver, the detected physiological state being detected from at least an output of a dashboard camera of the vehicle, and based on the predicted level of stress of the driver, adjust one or more controls of the vehicle. In a first example of the system, the predicted level of stress is determined using at least one of: an ML model, and a statistical model, and wherein the environmental sensor data and an estimated physiological state of the driver are inputs into the at least one of the ML model and the statistical model, and wherein the ML model is trained using the environmental sensor data and the detected physiological state of the driver collected under controlled conditions as inputs into the ML model, and a measured physiological state of the driver as ground truth data, the measured physiological state measured during the controlled conditions. In a second example of the system, optionally including the first example, the environmental sensor data includes at least one of: a detection of an incoming phone call, a detection of an outgoing phone call, a radio station selection, a media source selection, a media track selection, and one or more settings of an IVI system of the vehicle, wherein the environmental sensor data includes at least one of: a start of an active route of the vehicle, an end of the active route of the vehicle, a change of the active route of the vehicle, an added destination of the active route of the vehicle, an interactive mode selection of a navigational system of the vehicle, and a command by the driver to zoom in or zoom out of a map of the navigational system, and wherein the environmental sensor data includes at least one of: exterior camera data of the vehicle, proximity sensor data of the vehicle, radar data of the vehicle, lidar data of the vehicle, in-cabin sensor data, vehicle speed data, steering wheel angle data, brake pedal position data, accelerator pedal position data, a status of one or more lights of the vehicle, a status of a windshield wiper of the vehicle, a status of a turn indicator of the vehicle, a status of a sun roof of the vehicle, a status of an engine of the vehicle, and one or more instrument cluster warnings of the vehicle. In a third example of the system, optionally including one or both of the first and second examples, the adjustment of the one or more controls of the vehicle based on the predicted level of stress of the driver includes at least one of: adjusting a lighting of the cabin, adjusting a temperature of the cabin, adjusting a volume of an audio signal generated by an audio system of the vehicle, and terminating the audio signal and initiating a different audio signal.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the embodiments described above with respect to FIGS. 1-7. The methods may be performed by executing stored instructions with one or more logic devices (e.g., processors) in combination with one or more hardware elements, such as storage devices, memory, hardware network interfaces/antennas, switches, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A method, comprising:
collecting environmental status information inside a cabin of a vehicle during operation of the vehicle by a driver, the environmental status information related to environmental factors that may impact a cognitive load of the driver;
collecting driver status information from a driver monitoring system (DMS) of the vehicle;
predicting a physiological state of the driver based on the environmental status information and the driver status information; and
adjusting one or more environmental controls of the vehicle based on the predicted physiological state of the driver.

2. The method of claim 1, wherein the driver status information includes at least one of:
identification information of the driver;
output of a dashboard camera of the vehicle;
seat occupancy data of the vehicle;
interior illumination data of the vehicle;
biometric data of the driver;
a drowsiness assessment of the driver;
a stress assessment of the driver;
a distraction assessment of the driver;
eye gaze data of the driver;
head movement data of the driver; and
data of a guided audio intervention system of the vehicle.

3. The method of claim 1, wherein the environmental status information includes at least one of:
information from a navigational system of the vehicle;
information from an in-vehicle infotainment (IVI) system of the vehicle; and
information from one or more bus systems of the vehicle.

4. The method of claim 3, wherein the information from the navigational system includes at least one of:
a start of an active route of the vehicle;
an end of the active route of the vehicle;
a change of the active route of the vehicle;
an added destination of the active route of the vehicle;
an interactive mode selection of the navigational system; and
a command by the driver to zoom in or zoom out of a map of the navigational system.

5. The method of claim 3, wherein the information from the IVI system includes at least one of:
a detection of an incoming phone call;
a detection of an outgoing phone call;
a radio station selection;
a media source selection;
a media track selection; and
one or more settings of the IVI system.

6. The method of claim 3, wherein the information from the one or more bus systems of the vehicle includes sensor data of the vehicle, the sensor data including at least one of:
exterior camera data of the vehicle;
proximity sensor data of the vehicle;
radar data of the vehicle;
lidar data of the vehicle;
in-cabin sensor data;
vehicle speed data;
steering wheel angle data;
brake pedal position data;
accelerator pedal position data;
a status of one or more lights of the vehicle;
a status of a windshield wiper of the vehicle;
a status of a turn indicator of the vehicle;
a status of a sun roof of the vehicle;
a status of an engine of the vehicle; and
one or more instrument cluster warnings of the vehicle.

7. The method of claim 1, wherein adjusting the one or more environmental controls of the vehicle based on the predicted physiological state of the driver includes at least one of:
adjusting a lighting of the cabin;
adjusting a temperature of the cabin; and
adjusting an audio signal generated by an audio system of the vehicle.

8. The method of claim 7, wherein adjusting the audio signal further includes at least one of:
adjusting a volume of the audio signal; and
terminating the audio signal and initiating a different audio signal.

9. The method of claim 1,
wherein adjusting the one or more environmental controls of the vehicle based on the predicted physiological state of the driver includes adjusting the one or more environmental controls based upon at an output of least one of:
a machine learning (ML) model; and
a statistical model; and
wherein the environmental status information and the driver status information are inputs into the at least one of the ML model and the statistical model.

10. The method of claim 1, wherein adjusting the one or more environmental controls of the vehicle based on the predicted physiological state of the driver further includes adjusting the one or more environmental controls based on a classification of the driver.

11. A method, comprising:
using a trained machine learning (ML) model to predict a physiological state of a driver of a vehicle based on:
a detected physiological state of the driver, the detected physiological state being detected from a driver monitoring system (DMS) of the vehicle; and
one or more pieces of environmental status information, the environmental status information including data relevant to the physiological state of the driver; and
based on the predicted physiological state, adjusting one or more environmental controls of a cabin of the vehicle.

12. The method of claim 11, wherein the environmental status information further includes one or more of:
data of an in-vehicle infotainment (IVI) system of the vehicle;
data of a navigation system of the vehicle; and
data from one or more bus systems of the vehicle.

13. The method of claim 12,
wherein the data of the IVI system includes at least one of: a detection of an incoming phone call; a detection of an outgoing phone call; a radio station selection; a media source selection; a media track selection; and one or more settings of the IVI system;
wherein the data of the navigation system includes at least one of: a start of an active route of the vehicle; an end of the active route of the vehicle; a change of the active route of the vehicle; an added destination of the active route of the vehicle; an interactive mode selection of the navigation system; and a command by the driver to zoom in or zoom out of a map of the navigation system; and
wherein the data from one or more bus systems of the vehicle includes at least one of: exterior camera data of the vehicle; proximity sensor data of the vehicle; radar data of the vehicle; lidar data of the vehicle; in-cabin sensor data; vehicle speed data; steering wheel angle data; brake pedal position data; accelerator pedal position data; a status of one or more lights of the vehicle; a status of a windshield wiper of the vehicle; a status of a turn indicator of the vehicle; a status of a sun roof of the vehicle; a status of an engine of the vehicle; and one or more instrument cluster warnings of the vehicle.

14. The method of claim 11, wherein adjusting the one or more environmental controls of the vehicle based on the predicted physiological state of the driver includes at least one of:
adjusting a lighting of the cabin;
adjusting a temperature of the cabin; and
adjusting a volume of an audio signal generated by an audio system of the vehicle; and
terminating the audio signal and initiating a different audio signal.

15. The method of claim 11, wherein adjusting the one or more environmental controls of the cabin of the vehicle further includes:
in a first condition, where the predicted physiological state exceeds a threshold physiological state, adjusting the one or more environmental controls; and
in a second condition, where the predicted physiological state does not exceed the threshold physiological state, not adjusting the one or more environmental controls.

16. The method of claim 15, wherein the threshold physiological state is a threshold physiological state specific to the driver.

17. A system of a vehicle, comprising:
one or more processors having executable instructions stored in a non-transitory memory that, when executed, cause the one or more processors to:
predict a level of stress of a driver of the vehicle based on data including environmental sensor data of a cabin of the vehicle and a detected physiological state of the driver, the detected physiological state being detected from at least an output of a dashboard camera of the vehicle; and
based on the predicted level of stress of the driver, adjust one or more controls of the vehicle.

18. The system of claim 17,
wherein the predicted level of stress is determined using at least one of:
a machine learning (ML) model; and
a statistical model; and
wherein the environmental sensor data and an estimated physiological state of the driver are inputs into the at least one of the ML model and the statistical model; and
wherein the ML model is trained using the environmental sensor data and the detected physiological state of the driver collected under controlled conditions as inputs into the ML model, and a measured physiological state of the driver as ground truth data, the measured physiological state measured during the controlled conditions.

19. The system of claim 17,
wherein the environmental sensor data includes at least one of: a detection of an incoming phone call; a detection of an outgoing phone call; a radio station selection; a media source selection; a media track selection; and one or more settings of an in-vehicle infotainment (IVI) system of the vehicle;
wherein the environmental sensor data includes at least one of: a start of an active route of the vehicle; an end of the active route of the vehicle; a change of the active route of the vehicle; an added destination of the active route of the vehicle; an interactive mode selection of a navigational system of the vehicle; and a command by the driver to zoom in or zoom out of a map of the navigational system; and
wherein the environmental sensor data includes at least one of: exterior camera data of the vehicle; proximity sensor data of the vehicle; radar data of the vehicle; lidar data of the vehicle; in-cabin sensor data; vehicle speed data; steering wheel angle data; brake pedal position data; accelerator pedal position data; a status of one or more lights of the vehicle; a status of a windshield wiper of the vehicle; a status of a turn indicator of the vehicle; a status of a sun roof of the vehicle; a status of an engine of the vehicle; and one or more instrument cluster warnings of the vehicle.

20. The system of claim 17, wherein the adjustment of the one or more controls of the vehicle based on the predicted level of stress of the driver includes at least one of:
adjusting a lighting of the cabin;
adjusting a temperature of the cabin;
adjusting a volume of an audio signal generated by an audio system of the vehicle; and
terminating the audio signal and initiating a different audio signal.
